(19) United States
(12) Patent Application Publication
(10) Pub. No.: US 2026/0297266 A1
(43) Pub. Date: Oct. 1, 2026

(54) PHOSPHORUS-NITROGEN CAGE BASED HYBRID INORGANIC-ORGANIC POLYMERS

(71) Applicant: DALHOUSIE UNIVERSITY, Halifax (CA)

(72) Inventors: Saurabh S. CHITNIS, Halifax (CA); Mohsen SHAYAN, Newmarket (CA)

(21) Appl. No.: 19/474,626

(22) PCT Filed: Apr. 11, 2023
(86) PCT No.: PCT/CA2024/050461

§ 371 Date: Oct. 10, 2025

Related U.S. Application Data
(60) Provisional application No. 63/495,993, filed on Apr. 13, 2023.

(51) Int. Cl. C08G 79/025

(52) U.S. Cl. CPC C08G 79/025

(57) ABSTRACT

The present disclosure provides a polymeric reaction product formed from the polymerization of: (A) a phosphorus-nitrogen monomer according to Formula I, a phosphorus-nitrogen monomer according to Formula II, or a combination thereof; and (B) a monomer comprising a compound including at least two azide functional groups. The structure of Formula I and II are: Formula I Formula II where each R1 is independently an optionally substituted C1-C6 alkyl or C2-C6 alkenyl; and each R2 is independently an optionally substituted C1-C6 alkyl or C2-C6 alkenyl.

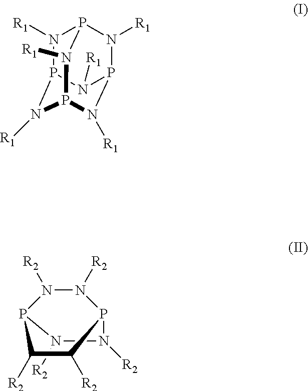

### CROSS REFERENCE TO RELATED APPLICATIONS

This application claims the benefit of U.S. Provisional Application No. 63/495,993, filed on Apr. 13, 2023, the contents of which are hereby incorporated herein by reference in their entirety.

### FIELD

The present disclosure related to phosphorus-nitrogen based hybrid inorganic-organic polymers.

### BACKGROUND

Polyphosphazene compounds include a wide range of hybrid inorganic-organic polymers with a number of different skeletal architectures with the backbone P—N—P—N—P—N—. Linear polymers have the formula (—N═PR¹R²—)ₙ, where R¹ and R² are organic. Cyclolinear and cyclomatrix polymers have small phosphazene rings connected together by organic chain units. Other architectures are available, such as block copolymer, star, dendritic, or comb-type structures.

Linear polyphosphazene compounds may be synthesized in a two-step process. In the first step hexachlorocyclotriphosphazene (NPCl₂)₃ is heated in a sealed system at 250° C. to convert it to a long chain linear polymer (—N═PCl₂—)ₙ with typically 15,000 or more repeating units. In the second step, the chlorine atoms linked to the phosphorus in the polymer are replaced by organic groups through reactions with alkoxides, aryloxides, amines or organometallic reagents.

Alternatively, polyphosphazene compounds may be synthesized using Cl₃P═N—SiMe₃ in a living cationic polymerization, which may be used to form block copolymers or comb, star, or dendritic architectures.

### INTRODUCTION

The following introduction is intended to introduce the reader to this specification but not to define any invention. One or more inventions may reside in a combination or sub-combination of the apparatus elements or method steps described below or in other parts of this document. The inventors do not waive or disclaim their rights to any invention or inventions disclosed in this specification merely by not describing such other invention or inventions in the claims.

Synthetic polymers are found in nearly all modern materials, such as plastics, resins, coatings, elastics, and composites. The properties of a polymer, such as its physicochemical, thermal, optoelectronic, preceramic or fire-retardant properties, are determined by the properties and structure of the monomeric repeating units. Synthetic polymers with one-dimensional rods (such as C—C bonds in polyethylene), two-dimensional rings (such as phenyl rings in polyphenylenes), and combinations thereof (such as C—C bonds and phenyl rings in polyaramides) are well known. However, synthetic polymers with three-dimensional entities are rare, and synthetic polymers with inorganic-based three-dimensional entities are even more rare.

Hybrid inorganic-organic polymers with three-dimensional entities provide polymeric structures that are distinct from organic polymers, and may result in polymers with beneficial properties, such as beneficial physicochemical, thermal, optoelectronic, preceramic or fire-retardant properties.

In one aspect, the present disclosure provides a polymeric reaction product formed from the polymerization of: (A) a phosphorus-nitrogen monomer according to Formula I, a phosphorus-nitrogen monomer according to Formula II, or a combination thereof; and (B) a monomer comprising a compound including at least two azide functional groups. The structures of Formulas I and II are:

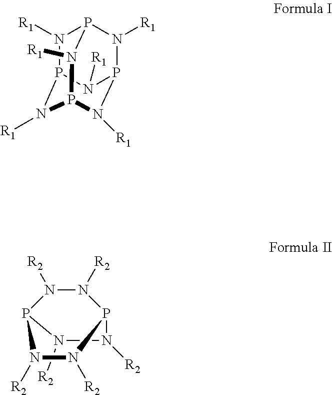

where each R₁ is independently an optionally substituted C₁-C₆ alkyl or C₂-C₆ alkenyl; and each R₂ is independently an optionally substituted C₁-C₆ alkyl or C₂-C₆ alkenyl.

In some examples: the polymeric reaction product lacks

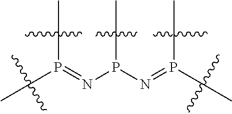

groups; at least one, and preferably all, of the azide functional groups in monomer (B) is bonded to a carbon atom; or both.

In some examples, the monomer (B) includes a compound with a structure according to N₃-A-N₃, where A is a linking group, such as an linking group that includes one or more of: an optionally substituted straight chain or branched alkyl, an optionally substituted alkenyl, an optionally substituted alkynyl, an optionally substituted aryl, an optionally substituted heteroaryl, an optionally substituted carbocyclic, or a phosphorus-nitrogen structure according to Formula II.

In some examples, the monomer (B) includes a compound according to:

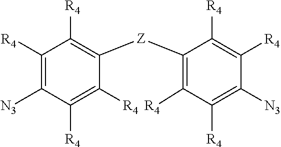

where Z is a bond or a linker that includes: —O—, —NR₃—, a carbonyl, an ester, an ether, an amide, an optionally substituted C₁-C₆ alkyl group, an optionally substituted aromatic group, or any combination thereof, where R₃ is an optionally substituted alkyl or aryl group; and where each R₄ is independently H or an electron-withdrawing functional group, for example fluorine.

In another aspect, the present disclosure provides a process for the preparation of a polymerization reaction product. The process includes reacting (A) a phosphorus-nitrogen monomer according to Formula I, a phosphorus-nitrogen monomer according to Formula II, or a combination thereof with (B) a monomer comprising a compound including at least two azide functional groups under anhydrous polymerization conditions. The structures of Formulas I and II are:

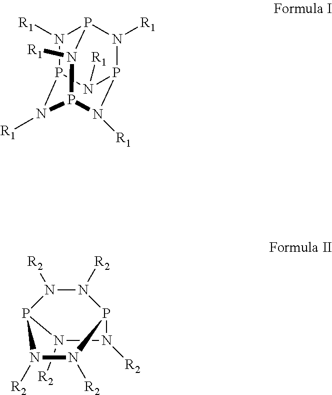

where each R₁ is independently an optionally substituted C₁-C₆ alkyl or C₂-C₆ alkenyl; and each R₂ is independently an optionally substituted C₁-C₆ alkyl or C₂-C₆ alkenyl.

The polymerization conditions may include polymerization at an elevated temperature, such as a temperature from about 25 to about 110° C., for example a temperature of about 60° C. to about 110° C. The elevated temperature may be provided by a heated oil bath.

The polymerization reaction of monomer (A) with monomer (B) may be in an aprotic solvent, preferably an aprotic solvent with a boiling point of between about 60° C. to about 110° C., such as tetrahydrofuran.

### BRIEF DESCRIPTION OF DRAWINGS

Examples according to the present disclosure will now be described, by way of example only, with reference to the attached Figures. In FIGS. 1 to 13, the unlabeled peaks are spinning sidebands.

FIG. 1 is a solid-state ³¹P NMR spectrum of the exemplary polymeric reaction product according to Example 2.

FIG. 2 is a solid-state ¹⁹F NMR spectrum of the exemplary polymeric reaction product according to Example 2.

FIG. 3 is a solid-state ¹H NMR spectrum of the exemplary polymeric reaction product according to Example 2.

FIG. 4 is a ³¹P{¹H} NMR (202 MHz) spectrum of the exemplary polymeric reaction product according to Example 3 in tetrahydrofuran.

FIG. 5 is a ¹⁹F NMR (471 MHz) spectrum of the exemplary polymeric reaction product according to Example 3 in tetrahydrofuran.

FIG. 6 is a solid-state ³¹P NMR spectra of the exemplary polymeric reaction product according to Example 4.

FIG. 7 is a solid-state ¹⁹F NMR spectra of the exemplary polymeric reaction product according to Example 4.

FIG. 8 is a solid-state ¹H NMR spectra of the exemplary polymeric reaction product according to Example 4.

FIG. 9 is a ³¹P{¹H} NMR (202 MHz) spectrum of the exemplary polymeric reaction product according to Example 5 in tetrahydrofuran.

FIG. 10 a ¹⁹F NMR (471 MHz) spectrum of the exemplary polymeric reaction product according to Example 5 in tetrahydrofuran.

FIG. 11 is a solid-state ³¹P NMR spectra of the exemplary polymeric reaction product according to Example 5.

FIG. 12 a solid-state ¹⁹F NMR spectra of the exemplary polymeric reaction product according to Example 5.

FIG. 13 is solid-state ¹H NMR spectra of the exemplary polymeric reaction product according to Example 5.

FIG. 14 is a photograph showing the contact angle of two drops of water, one drop on a glass surface coated with the exemplary polymeric reaction product according to Example 5, and the other drop on the uncoated glass surface.

### DETAILED DESCRIPTION

An optionally substituted alkyl group according to the present disclosure may independently have: from 1 to 20 carbon atoms, wherein up to 10 CH or CH₂ groups may independently be replaced by a group selected from —O—, —NR—, —NR₂, —S—, —S(O)—, —SO₂—, —S(O)(NR)—, —S(O₂)(NR)—, —N(SO)R—, —C(O)—, —CO₂—, —OC(O)—, —C(O)NR—, —NRC(O)—, —C(NOR)—, and R; wherein each R independently denotes: H, D, an optionally substituted straight chain or branched alkyl group, an optionally substituted alkenyl group, an optionally substituted alkynyl group, an optionally substituted aryl group, an optionally substituted heteroaryl group, or an optionally substituted carbocyclic group.

An optionally substituted alkenyl according to the present disclosure may independently have at least one carbon-carbon double bond, and may independently have 2 to 20 carbon atoms, where up to 10 CH or CH₂ groups may be independently replaced by a group selected from —O—, —NR—, —NR₂, —S—, —S(O)—, —SO₂—, —S(O)(NR)—, —S(O₂)(NR)—, —N(SO)R—, —C(O)—, —CO₂—, —OC(O)—, —C(O)NR—, —NRC(O)—, —C(NOR)—, and R; where each R independently denotes: H, D, an optionally substituted straight chain or branched alkyl group, an optionally substituted alkenyl group, an optionally substituted alkynyl group, an optionally substituted aryl group, an optionally substituted heteroaryl group, or an optionally substituted carbocyclic group.

An optionally substituted alkynyl according to the present disclosure may independently have at least one carbon-carbon or carbon-nitrogen triple bond, and may independently have 2 to 20 carbon atoms, where up to 10 CH or CH₂ groups may be independently replaced by a group selected from —O—, —NR—, —NR₂, —S—, —S(O)—, —SO₂—, —S(O)(NR)—, —S(O₂)(NR)—, —N(SO)R—, —C(O)—, —CO₂—, —OC(O)—, —C(O)NR—, —NRC(O)—, —C(NOR)—, and R; wherein each R independently denotes: H, D, an optionally substituted straight chain or branched alkyl group, an optionally substituted alkenyl group, an optionally substituted alkynyl group, an optionally substituted aryl group, an optionally substituted heteroaryl group, or an optionally substituted carbocyclic group.

An optionally substituted aryl group according to the present disclosure may be independently: a monocyclic aromatic ring, a multicyclic aromatic ring system, or a fused multicyclic aromatic ring system having 3- to 18-members. Each monocyclic aromatic ring of the optionally substituted aryl group may be independently —C₆H₅ or —CH₂C₆H₅. Each multicyclic aromatic ring of the optionally substituted aryl group may be independently —C₆H₄C₆H₅ or —CH₂C₆H₄C₆H₅. Each fused multicyclic aromatic ring of the optionally substituted aryl group may be independently —C₁₀H₇ or —CH₂C₁₀H₇.

An optionally substituted heteroaryl group according to the present disclosure may be independently: a monocyclic aromatic ring, a multicyclic aromatic ring, or a fused multicyclic aromatic ring system having 3- to 18-members and containing 1 to 6 heteroatoms selected from N, O and S.

An optionally substituted carbocyclic group according to the present disclosure may be a saturated or an unsaturated carbocyclic ring having from 3 to 20 carbon atoms, where up to 10 CH or CH₂ groups may independently be replaced by a group selected from —O—, N, —NR—, —S—, —S(O)—, —SO₂—, —S(O)(NR)—, —N(SO)R—, —C(O)—, —CO₂—, —OC(O)—, —C(O)NR—, and —NRC(O)—, where each R independently denotes: H, D, an optionally substituted straight chain or branched alkyl group, an optionally substituted alkenyl group, an optionally substituted alkynyl group, an optionally substituted aryl group, an optionally substituted heteroaryl group, or an optionally substituted carbocyclic group.

In the context of the present disclosure, the term “EWG substituted-aryl variant thereof” should be understood to refer to the referenced aryl group with one or more electron-withdrawing functional groups, such as —F, —CF₃, —C₂F₅, —NO₂, —Cl, —SO₂R′, carbonyl, —SF₅, —NR′₃⁺, —CO₂R′, or —C₆F₅, where each R′ is independently an optionally substituted straight chain or branched alkyl group, an optionally substituted alkenyl group, an optionally substituted alkynyl group, an optionally substituted aryl group, an optionally substituted heteroaryl group, an optionally substituted carbocyclic group. For example, if a contemplated compound included a —C₆H₄— group, a EWG substituted-aryl variant thereof includes the contemplated compound with a —C₆F₄— or a —C₆H₃CF₃— group.

In one aspect, the present disclosure provides a polymeric reaction product formed from the polymerization of: (A) a phosphorus-nitrogen monomer according to Formula I, a phosphorus-nitrogen monomer according to Formula II, or a combination thereof; and (B) a monomer including a compound having at least two azide functional groups.

In another aspect, the present disclosure provides a process for the preparation of a polymerization reaction product. The process includes: reacting (A) a phosphorus-nitrogen monomer according to Formula I, a phosphorus-nitrogen monomer according to Formula II, or a combination thereof with (B) a monomer including a compound having at least two azide functional groups. The reaction is under anhydrous polymerization conditions.

The structures of Formulas I and II are:

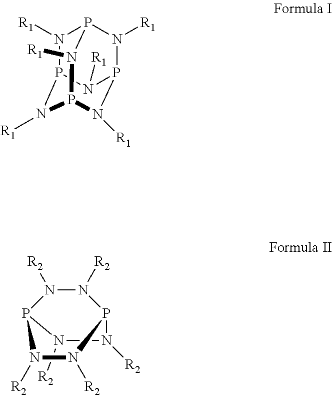

where each R₁ is independently an optionally substituted C₁-C₆ alkyl or C₂-C₆ alkenyl; and each R₂ is independently an optionally substituted C₁-C₆ alkyl or C₂-C₆ alkenyl.

The polymerization conditions may include polymerization at an elevated temperature, such as a temperature from about 25 to about 110° C., for example a temperature of about 60° C. to about 110° C. The elevated temperature may be provided by a heated oil bath.

The polymerization reaction of monomer (A) with monomer (B) may be in an aprotic solvent, preferably an aprotic solvent with a boiling point of between about 60° C. to about 110° C., such as tetrahydrofuran.

An optional substituent for R₁ and R₂ may be independently selected from the group consisting of: D, halogen, an optionally substituted straight chain or branched alkyl group, an optionally substituted alkenyl group, an optionally substituted alkynyl group, an optionally substituted aryl group, an optionally substituted heteroaryl group, or an optionally substituted carbocyclic group.

In various examples, each R₁ and R₂ may be independently methyl, ethyl, benzyl, —(CH₂)ₙ—CH═CH₂ where n is from 0 to 10 (such as vinyl or allyl), or —(CH₂)ₘ-Ph-CH═CH₂ where m is from 1 to 5.

The monomer (B) may include a mixture of different azide-containing compounds.

In some examples, the polymeric reaction product does not include phosphorus-nitrogen-phosphorus structures, such as

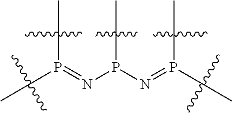

groups. In some examples, at least one (and preferably all) of the azide functional groups in monomer (B) is bonded to a carbon atom.

In some examples, the monomer (B) includes a compound with a structure according to N₃-A-N₃, where A is a linking group. The linking group may include one or more of: a metal, an optionally substituted straight chain or branched alkyl, an optionally substituted alkenyl, an optionally substituted alkynyl, an optionally substituted aryl, an optionally substituted heteroaryl, an optionally substituted carbocyclic, an optionally substituted heteroborane such as an optionally substituted carboranyl, or a phosphorus-nitrogen structure according to Formula II.

In particular examples, A is a linking group that includes one or more aryl groups substituted with at least one electron-withdrawing functional group, such as —F, —CF₃, —C₂F₅, —NO₂, —Cl, —SO₂R′, carbonyl, —SF₅, —NR′₃⁺, —CO₂R′, or —C₆F₅, where each R′ is independently an optionally substituted straight chain or branched alkyl group, an optionally substituted alkenyl group, an optionally substituted alkynyl group, an optionally substituted aryl group, an optionally substituted heteroaryl group, or an optionally substituted carbocyclic group.

In various examples, the monomer (B) may include a compound according to:

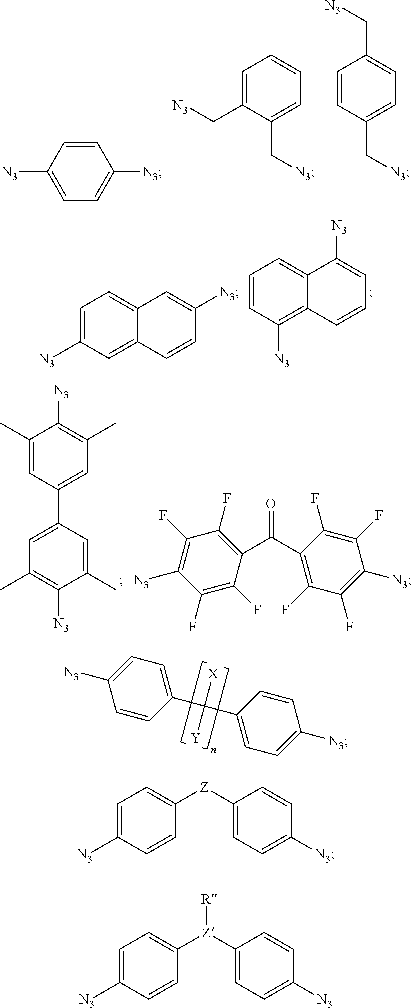

wherein Z′ is P, As, Sb, or Bi and R″ is an optionally substituted aryl group

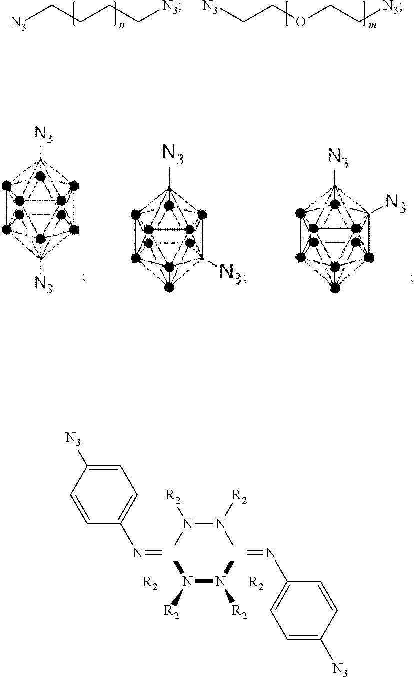

wherein each R₂ is independently as defined above;

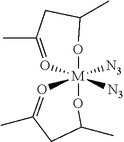

wherein M is Sn, Ge, or Si;

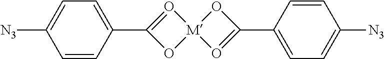

wherein M′ is Sc, Ti, Cr, Mn, Fe, Co, Ni, Cu, or Zn (preferably Co or Zn);

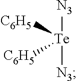

or any EWG substituted-aryl variant thereof.

In the exemplary compounds illustrated above: X is H, D, halogen, an optionally substituted straight chain or branched alkyl group, an optionally substituted alkenyl group, an optionally substituted alkynyl group, an optionally substituted aryl group, an optionally substituted heteroaryl group, or an optionally substituted carbocyclic group; Y is H, D, halogen, an optionally substituted straight chain or branched alkyl group, an optionally substituted alkenyl group, an optionally substituted alkynyl group, an optionally substituted aryl group, an optionally substituted heteroaryl group, or an optionally substituted carbocyclic group; n is an integer from 1 to 3; m is an integer from 1 to 1000; Z is bond or a linker that includes: —O—, —NR₃—, a carbonyl, an ester, an ether, an amide, an optionally substituted C₁-C₆ alkyl group, an optionally substituted aryl group, —S—, —Se—, —Te—, —S(O)—, —Se(O)—, —Te(O)—, or any combination thereof, wherein R₃ is an optionally substituted alkyl or aryl group; and • is B—H. The EWG substituted-aryl variant may be

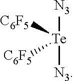

In some specific examples, the monomer (B) includes a compound according to

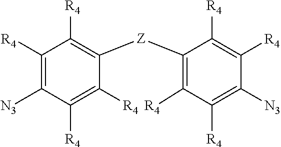

where Z is a bond or a linker that includes: —O—, —NR₃—, a carbonyl, an ester, an ether, an amide, an optionally substituted C₁-C₆ alkyl group, an optionally substituted aromatic group, or any combination thereof, where R₃ is an optionally substituted alkyl or aryl group; and where each R₄ is independently H or an electron-withdrawing functional group, for example fluorine.

In some examples, a polymeric reaction product according to the present disclosure is formed from a polymerization reaction where monomer (B) is

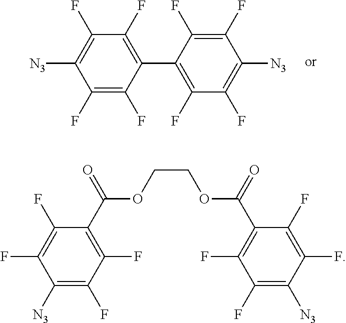 [SMILES: [N-]=[N+]=Nc1c(F)c(F)c(-c2c(F)c(F)c(N=[N+]=[N-])c(F)c2F)c(F)c1F ; [N-]=[N+]=Nc1c(F)c(F)c(C(=O)OCCOC(=O)c2c(F)c(F)c(N=[N+]=[N-])c(F)c2F)c(F)c1F]

In other examples, a polymeric reaction product according to the present disclosure is formed from a polymerization reaction where monomer (B) is not

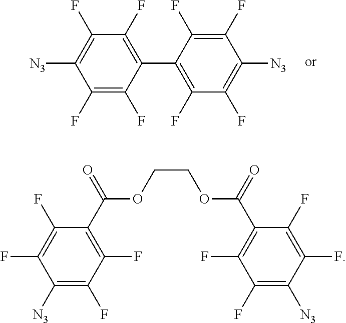 [SMILES: [N-]=[N+]=Nc1c(F)c(F)c(-c2c(F)c(F)c(N=[N+]=[N-])c(F)c2F)c(F)c1F ; [N-]=[N+]=Nc1c(F)c(F)c(C(=O)OCCOC(=O)c2c(F)c(F)c(N=[N+]=[N-])c(F)c2F)c(F)c1F]

In some examples according to the present disclosure, the reaction product of monomer (A) and monomer (B) includes:

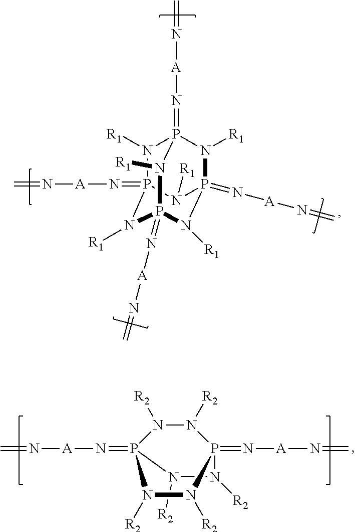

or a combination thereof, where each A may be the same or different.

In some examples, R₁ is ethyl, the monomer (A) includes the phosphorus-nitrogen monomer according to Formula I, and the reaction product of monomer (A) and monomer (B) includes:

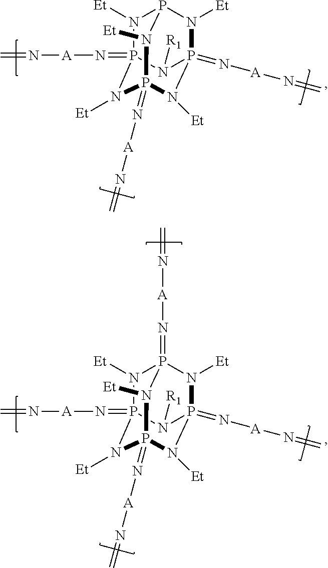

or a combination thereof, where each A may be the same or different.

It should be understood that the above structures illustrate partial structures of the polymeric product, but not the repeating monomer unit since the illustrated structure ends with -A-N═] groups, which would be bonded to adjacent phosphorus atoms.

The monomer (B) may include a compound with at least three azide groups linked by: a metal, an optionally substituted straight chain or branched alkyl, an optionally substituted alkenyl, an optionally substituted alkynyl, an optionally substituted aryl, an optionally substituted heteroaryl, or an optionally substituted carbocyclic. For example, the monomer (B) may include a compound according to

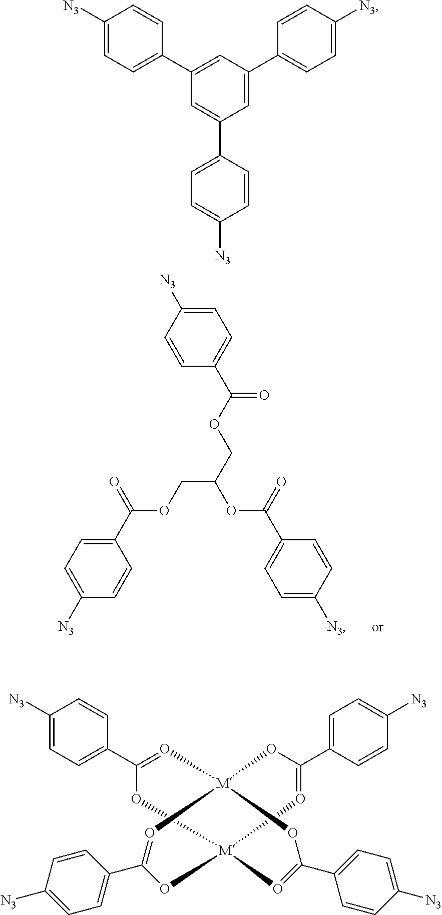

where M′ is Sc, Ti, Cr, Mn, Fe, Co, Ni, Cu, or Zn, preferably Co or Zn, or a EWG substituted-aryl variant thereof.

For example, the monomer (B) may include a compound according to

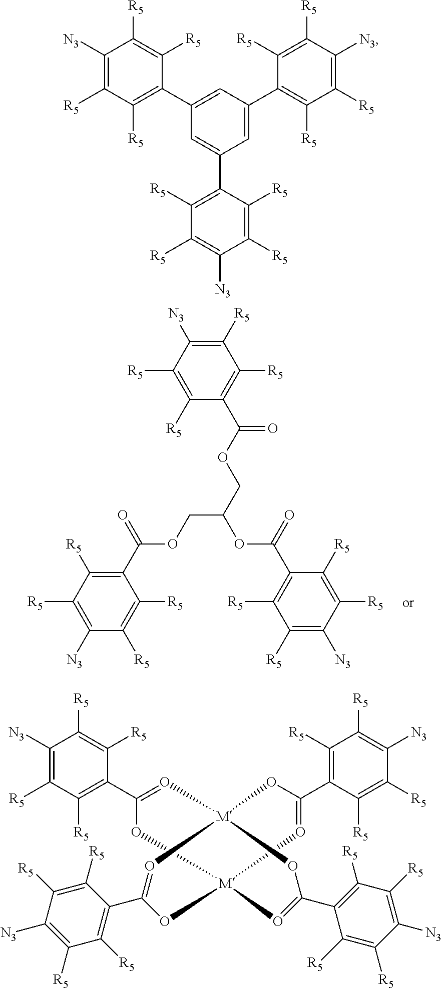

where each R₅ is independently H or an electron-withdrawing functional group, for example fluorine.

In exemplary products and methods according to the present disclosure, the monomer (A) may be a mixture of (i) the phosphorus-nitrogen monomer according to Formula I and (ii) the phosphorus-nitrogen monomer according to Formula II in a molar ratio of from 1:100 to 100:1, such as a molar ratio of about 10:90, about 20:80, about 30:70, about 40:60, about 50:50, about 60:40, about 70:30, about 80:20, or about 90:10.

In various examples according to the present disclosure, each R₁ is not methyl and/or each R₂ is not methyl.

In some examples, a polymeric product according to the present disclosure may include a structure according to Formula III, Formula IV, or a combination thereof, where R₁ and R₂ are defined above, for example methyl or ethyl:

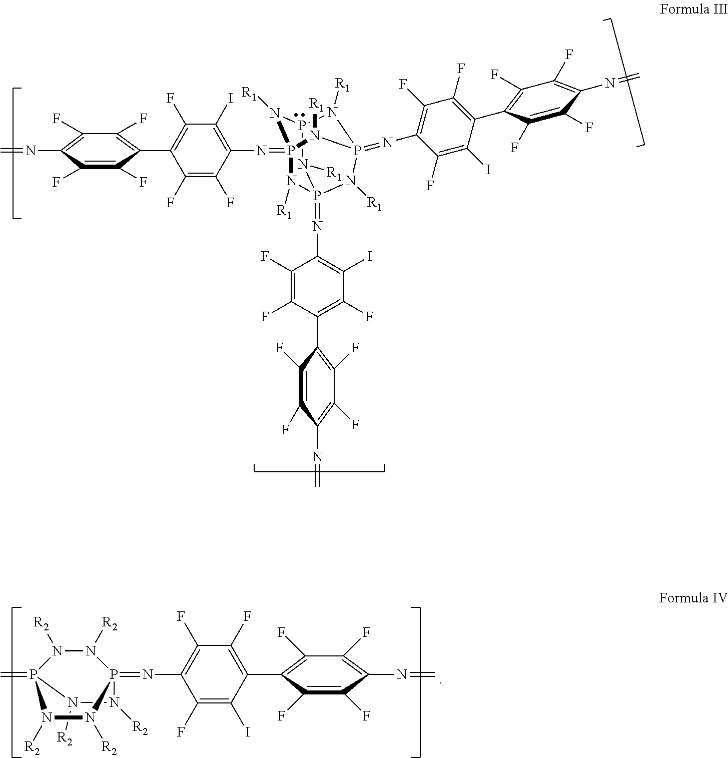

It should be understood that Formula III illustrates a partial structure of the polymeric product, but not the repeating monomer unit since the illustrated structure ends with —C₆F₄—N═] groups, which would be bonded to adjacent phosphorus atoms.

In some examples, a polymeric product according to the present disclosure may be a metal-organic PN polymer, such as a product that includes a plurality of repeating units according to Formula V, or a EWG substituted-aryl variant thereof, where R₂ is defined above, for example methyl or ethyl, and M′ is Sc, Ti, Cr, Mn, Fe, Co, Ni, Cu, or Zn, preferably Co or Zn:

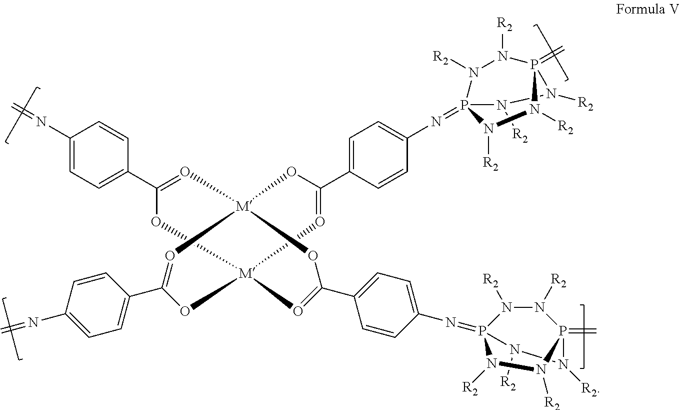

It should be understood that each of the four branches in the structure illustrated in Formula V may be bonded to separate units. Accordingly, Figure V illustrates a partial structure of the polymeric product. Figure V does not illustrate a repeating monomer unit where the two groups ending in P═] are bonded to two [═N— groups from one adjacent monomer unit.

A phosphorus-nitrogen monomer according to Formula I may be made according to the procedures discussed by Holmes in J. Am. Chem. Soc. 1960, 82, 5509-5510; J. Am. Chem. Soc. 1961, 83, 1334-1336; Inorg. Chem. 1963, 2, 377-380; or Inorg. Synth. 1966, 8, 63-68. Generally, neat PCl₃ is added dropwise over 25 minutes to a mechanically stirred 500-1000-fold excess of the neat liquid amine RNH₂ at −78° C. Once addition is complete, the reaction mixture is warmed to 90° C. and held at this temperature for 16 hours, resulting in the formation (either as precipitate or dissolved) of RNH₃Cl and formation of the corresponding P₄N₆R₆ cage. Following removal of unreacted amine under vacuum, the P₄N₆R₆ cage is separated from the RNH₃Cl by-product by extracting with anhydrous pentane (100× volume of PCl₃ used). Vigorous mechanical stirring may be used to help extract the product from the salt. Removal of pentane under vacuum yields the desired cage as a solid or oil.

A phosphorus-nitrogen monomer according to Formula II may be made according to the procedures discussed in Chem. Commun. 1965, 327-329; Phosphorous and Sulfur and the Related Elements 1979, 6, 391-395; or Inorganic Chemistry 1974, 13, 737-738. Generally, neat P(NMe₂)₃(2 equivalents) is added to a suspension of the corresponding hydrazine dihydrochloride (e.g. MeHN-NHMe*2HCl in the exemplary case here, 3 equivalents) in anhydrous toluene (50× volume when compared to volume of P(NMe₂)₃ used). It should be understood that the methyl groups in this example could be replaced with alternative groups according to the definition of R₂ in Formula II. This reaction mixture is refluxed under dry nitrogen for 72 h and then cooled. The reaction is filtered under nitrogen to separate the solid by-product. Toluene is then removed under vacuum, and the product extracted using anhydrous pentane (2×volume of toluene used). Removal of pentane under vacuum leaves behind the desired cage as a solid or oil.

### Example 1

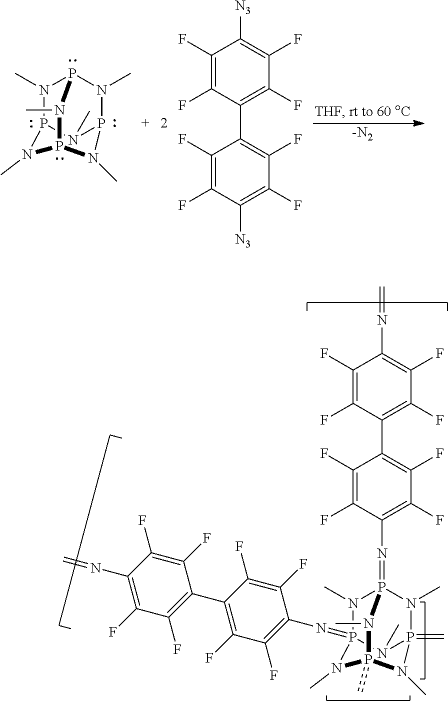

Inside a glovebox, a compound according to Formula I where R₁ is methyl (298.15 g/mol, 0.248 mmol, 74.0 mg) and 4,4-diazido-2,2′,3,3′,5,5′,6,6′-octafluoro-1,1′-biphenyl (380.16 g/mol, 0.4998 mmol, 190.0 mg, 2.0 equ.) were added to a 25 mL pressure tube equipped with a threaded PTFE cap. Tetrahydrofuran (THF, 9.60 mL) was added to obtain a clear yellow solution then the reaction vessel was capped and stirred at room temperature over night, then then light yellow solution was heated to 60° C. in an oil bath for four days with stirring. A pale yellow slightly cloudy solution obtained. Volatiles were removed under vacuum when stirring the solution to obtain a 2 mL clear light yellow highly viscous solution. The solution was used for making films by drop-casting on a Teflon mold.

### Example 2

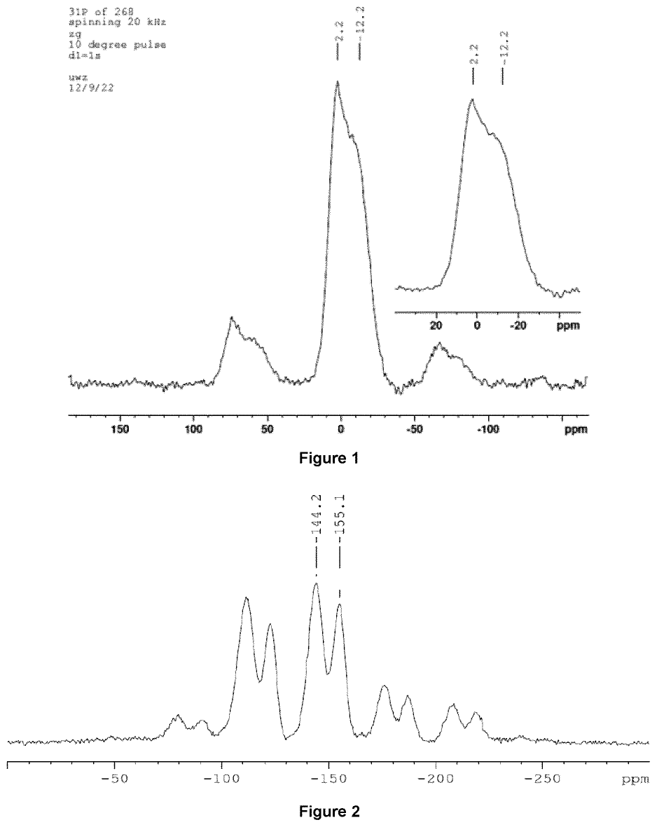

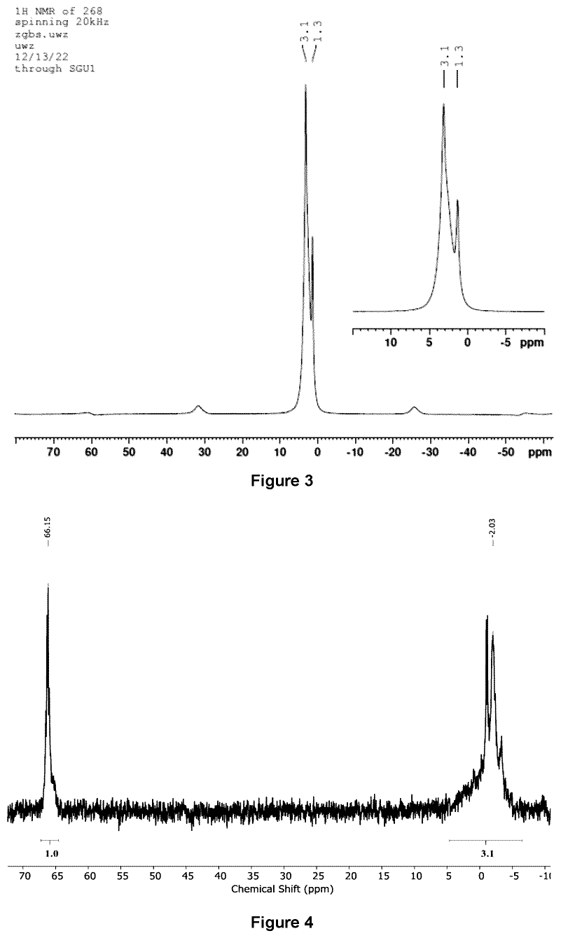

Inside a glovebox, a compound according to Formula I where R₁ is methyl (298.15 g/mol, 0.294 mmol, 87.8 mg) and 4,4′-diazido-2,2′,3,3′,5,5′,6,6′-octafluoro-1,1′-biphenyl (380.16 g/mol, 0.589 mmol, 223.9 mg, 2.00 equ.) were added to a 4 Dr vial. Tetrahydrofuran (THF, 3.75 mL) was added to obtain a clear yellow solution (nitrogen bubbles emerge immediately) then the vial was capped and left for two days at room temperature in the glove box without stirring upon which a yellow clear gel was obtained. Volatiles were removed under vacuum to obtain a yellow hard solid. The solid material was soaked in THF over night to obtain a soft gel again. This gel can absorb 100-270% (w/w) THF by swelling. Similarly, this gel swells in dichloromethane and ethanol. The gel was washed by repeating the swelling two more times and replacing the THF with fresh THF in each round. Finally, the gel was dried under vacuum for two days at ambient temperature to obtain a hard solid. The solid was crushed with a mortar and pestle and analyzed by ³¹P, ¹⁹F, and ¹H solid-state NMR spectroscopy. The NMR spectra are shown in FIGS. 1 to 3.

Decomposition onset points (TGA): 5% decomposition at 267.4° C.

IR (NaCl plate, cm⁻¹): 3668, 3439, 2953, 2893, 2827, 2537, 2393, 2123, 1777, 1648, 1480, 1322, 1219, 1034, 966, 870, 721, 676 cm⁻¹.

¹H ssNMR: δ 3.1 (N-Me) ppm. The peak at 1.3 ppm corresponds to residual THF.

³¹P ssNMR: δ 2.2 to −12.2 (broad, cage) ppm.

¹⁹F ssNMR: δ −144.2 (sharp, Ar—F), −155.1 (sharp, Ar—F) ppm.

### Example 3

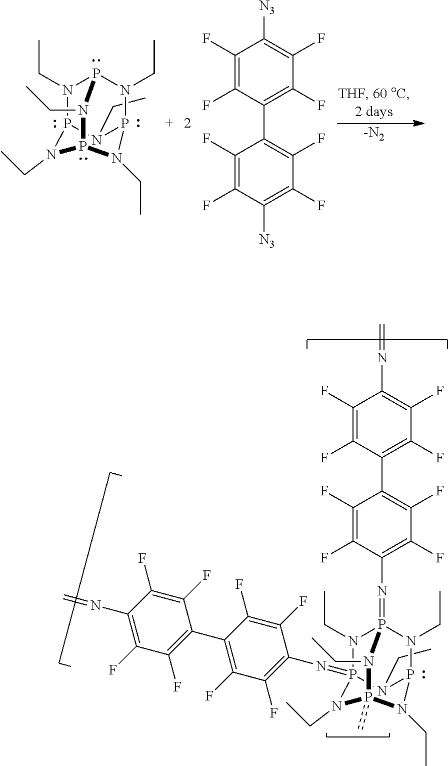

Inside a glovebox, a compound according to Formula I where R₁ is ethyl (382.31 g/mol, 0.253 mmol, 96.9 mg) and 4,4′-diazido-2,2′,3,3′,5,5′,6,6′-octafluoro-1,1′-biphenyl (380.16 g/mol, 0.5069 mmol, 192.7 mg, 2.00 equ.) were added to 25 mL pressure tube equipped with a threaded PTFE cap. THF (9.70 mL) was added to obtain a clear yellow solution then the reaction vessel was capped and heated to 60° C. in an oil bath for five days with stirring. A pale-yellow clear solution obtained. Volatiles were removed under vacuum when stirring the solution to obtain a 1 mL clear yellow viscous solution. This viscous solution was used for making films by drop-casting on a Teflon mold. ³¹P{¹H} and ¹⁹F NMR spectra of the polymer solution are shown in FIGS. 4 and 5, respectively. The ³¹P NMR spectrum indicates that three of the four phosphorous sites participate in the network.

### Example 4

Inside a glovebox, a compound according to Formula I where R₁ is ethyl (382.31 g/mol, 0.2676 mmol, 102.3 mg) and 4,4′-diazido-2,2′,3,3′,5,5′,6,6′-octafluoro-1,1′-biphenyl (380.16 g/mol, 0.535 mmol, 203.4 mg, 2.00 equ.) were added to 25 mL pressure tube equipped with a threaded PTFE cap. THF (3.40 mL) was added to obtain a clear yellow solution then the reaction vessel was capped and heated to 60° C. in an oven for two days, without stirring. A light-yellow clear gel was obtained. Volatiles were removed under vacuum to obtain yellow hard solid.

The solid material was soaked in THF over night to obtain a soft gel again. This gel can absorb 500-600% (w/w) THF by swelling. Similarly, this gel swells in dichloromethane, acetone, ethyl acetate, DMF, diethyl ether, dioxane, toluene, and xylene.

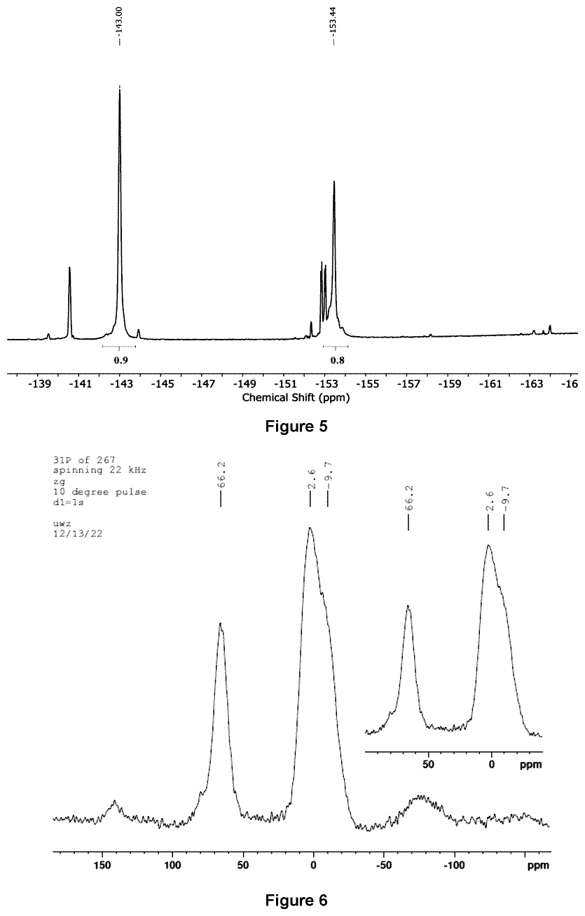

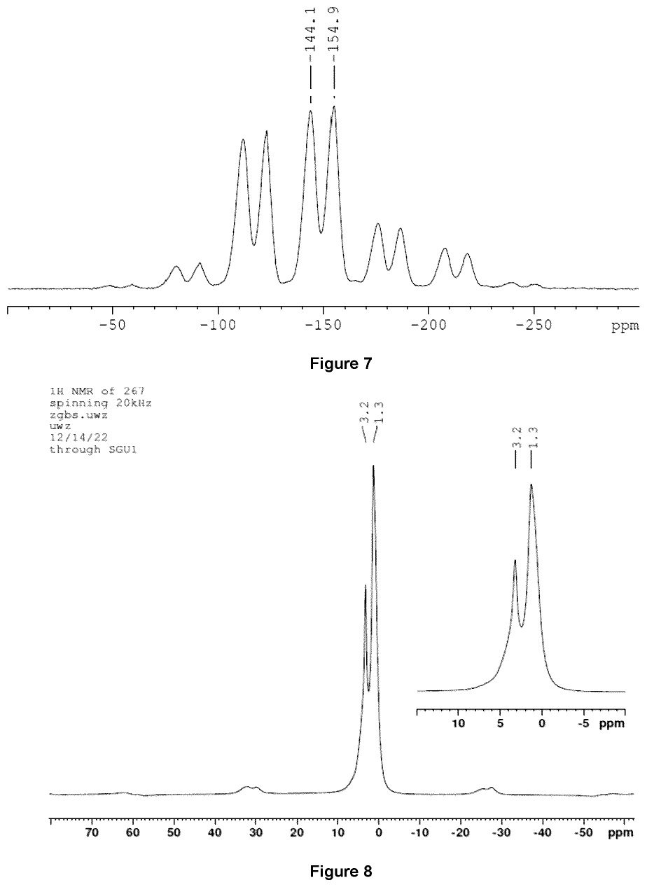

The gel was washed by repeating the swelling two more times and replacing the THF with fresh THF in each round. Finally, the gel was dried under vacuum for two days at ambient temperature to obtain a hard solid. The solid was crushed with a mortar and pestle and analyzed by ³¹P, ¹⁹F, and ¹H solid-state NMR spectroscopy. The NMR spectra are shown in FIGS. 6 to 8.

Decomposition onset points (TGA): 5% decomposition at 357.9° C.

IR (NaCl plate, cm⁻¹): 3406, 2979, 2936, 2875, 2536, 2470, 2394, 2122, 1647, 1530, 1479, 1382, 1315, 1217, 1165, 1054, 965, 930, 884, 772, 720, 672, 634.

¹H ssNMR: δ 3.2 (N-Me), 1.3 (N-Me) ppm.

³¹P ssNMR: δ 66.2 (sharp, cage), 2.6 to −9.7 (broad, cage) ppm.

¹⁹F ssNMR: δ −144.1 (sharp, Ar—F), −154.9 (sharp, Ar—F) ppm.

### Example 5

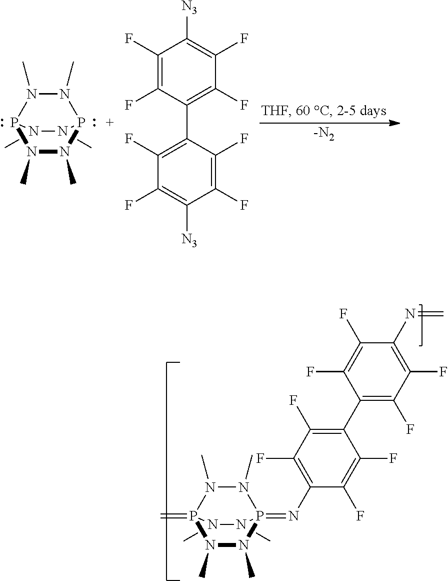

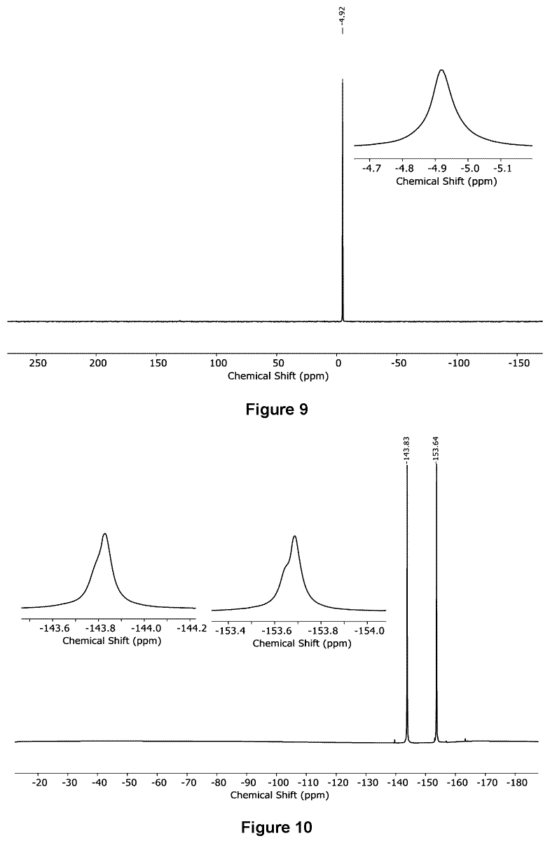

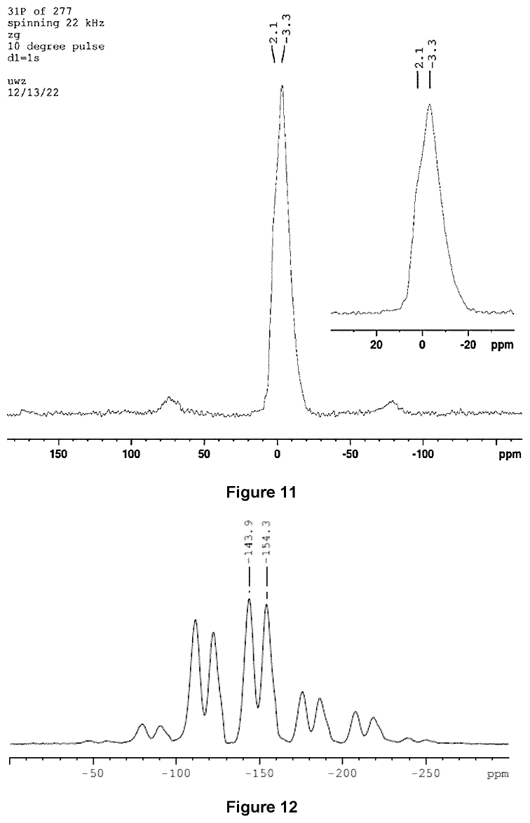

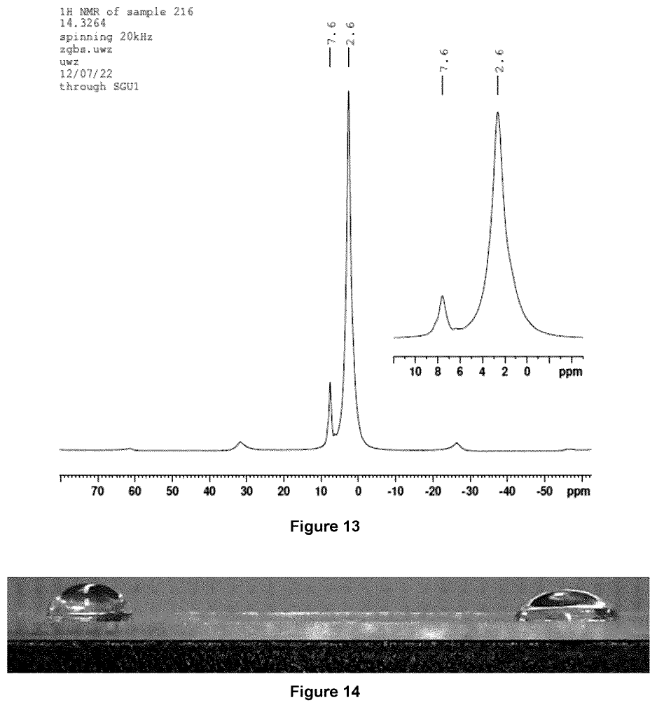

Inside a glovebox, a compound according to FIG. II where R² is methyl (236.2 g/mol, 0.5191 mmol, 122.6 mg) and 4,4′-diazido-2,2′,3,3′,5,5′,6,6′-octafluoro-1,1′-biphenyl (380.16 g/mol, 0.5193 mmol, 197.4 mg, 1.00 equ.) were added to 25 mL pressure tube equipped with a threaded PTFE cap. THF (4.40 mL) was added to obtain a clear yellow solution then the reaction vessel was capped and heated to 60° C. in an oil bath for five days with stirring upon which a pale yellow viscous solution was obtained. This viscous solution was used for making films by drop-casting on a Teflon mold and glass slide. Gel permeation chromatography analysis shows that this polymer has Mn=16000 and Mw=26000. ³¹P{¹H}NMR and ¹⁹F NMR spectra of the polymer viscous solution are shown in FIGS. 9 and 10, respectively. The viscous solution was dried under vacuum for two days at ambient temperature. The solid was crushed with a mortar and pestle and analyzed by ³¹P, ¹⁹F, and ¹H solid-state NMR spectroscopy. The NMR spectra are shown in FIGS. 11 to 13.

IR (NaCl plate, cm⁻¹): 2965, 2939, 2901, 2798, 2534, 1643, 1544, 1479, 1412, 1329, 1213, 1114, 1058, 965, 904, 780, 743, 676 cm⁻¹.

³¹P NMR (202 MHz, THF): −4.92 (s, 2P, cage) ppm.

¹⁹F NMR (471 MHz, THF): −143.81 (m, 4F), −153.64 (m, 4F) ppm.

¹H ssNMR: δ 2.6 (N-Me) ppm.

³¹P ssNMR: δ 2.1 to −3.3 (broad, cage) ppm.

¹⁹F ssNMR: δ −143.9 (sharp, Ar—F), −154.3 (sharp, Ar—F) ppm.

Polymer molecular weight measured by gel permeation chromatograph (GPC): 26,000 g·mol⁻¹ (M_{w}), 16,000 g·mol⁻¹ (Mₙ)

The polymeric compound was alternative made as follows:

Inside a glovebox and in a pressure tube equipped with stir bar and a threaded PTFE, a solution of the compound according to FIG. II where R² is methyl (0.500 g, 2.17 mmol) in 10 mL THF was mixed with a solution of 4,4′-diazido-2,2′,3,3′,5,5′,6,6′-octafluoro-1,1′-biphenyl (0.804 g, 2.116 mmol) in 10 mL THF. Combining the solutions led to the emergence of N₂ bubbles and a clear colorless solution formed. The reaction continued at 60° C. in an oil bath for 3 days which formed a viscous solution upon completion and the N₂ bubbles stopped. The solution was cast in a Teflon pan to form an opaque film. The physical properties of the film could be adjusted through changing the concentration via dilution/or evaporation of the solvent.

### Example 6

The polymeric reaction product of Example 5 was tested to determine any fire-retardant properties.

In a first test, one end of a cotton swab was soaked in a solution of the polymeric reaction product in THF to absorb the polymer. After drying, a flame torch was aimed at the cotton swab. This caused the cotton to burn but the burning stopped as soon as the torch was put away from the cotton swab. As a control, the other end of the cotton swab that was not soaked in the polymeric reaction product was set to fire by the torch and the cotton continued burning after the torch was removed.

In a second test, a film of the polymeric reaction product was exposed to the flame of a torch. This generated a white smoke and the film turned into a black char without significant change in the shape and size of the film. In addition, this process did not generate flame or soot. As a control, a piece of kitchen plastic wrap was subjected to the torch flame. The plastic wrap was burned with noticeable flame and soot.

### Example 7

The polymeric reaction product of Example 5 was tested to determine its hydrophobic properties.

The polymeric reaction product was used to coat the surface of a glass slide. Coating the glass was done by pouring the viscous solution on a glass slide, then another glass slide was placed on top and was dragged parallel to the surface. FIG. 14 illustrates the contact angle of a drop of water on the coated surface (left side) vs. on the uncoated glass surface (right side). When the surface of the glass slide was titled, the drop of water on the coated surface slid down the surface until it reached the uncoated glass surface.

### Example 8

The polymeric reaction product of Example 5 was tested to determine resistance to various conditions.

The polymeric reaction product was exposed to acids, basic conditions, oxidants, ultraviolet radiation, and low temperature conditions.

The polymeric reaction product was resistant to 6 M solutions of NaOH in water, HCl, and concentrated acetic acid (glacial). This was determined by placing a film of the polymeric reaction product on top of a piece of pH indicator paper. A drop of the test solution was placed on top of the polymeric film. If the test solution was capable of damaging the polymeric film, the test solution would pass through the polymeric film and the pH indicator would turn color. The polymeric film was not damaged by the noted solutions. However, the polymeric film was determined to be permeable to HCl vapor.

A film of the polymeric reaction product was exposed to iodine vapor for 24 hours in a capped vial. The polymer changed color from colorless to transparent brown, but the film did not loose its flexibility or integrity.

A film of the polymeric reaction product was exposed to UV radiation for 24 hours. The polymer slightly changed color to light transparent brown, but the film did not loose its flexibility or integrity.

A film of the polymeric reaction product was exposed to liquid nitrogen (−196° C.) and the polymer was manipulated while in the liquid nitrogen by pulling, twisting, and bending the film when holding the polymeric film with two sets of tweezers.

A film of the polymeric reaction product was exposed to concentrated nitric acid (70%), and to concentrated sulfuric acid. Exposure to the nitric acid caused degradation of the polymeric material. Exposure to the sulfuric acid caused the polymeric material to dissolve to a clear, colorless solution.

### Example 9

The polymeric reaction product of Example 5 was tested to determine its solubility in various solvent.

The polymer film was determined to be soluble in THF, orthodichlorobenzene, chloroform, and toluene. The polymer film was determined to be less soluble in dichloromethane, dimethylformamide, and ethyl acetate. The polymer film was determined to be insoluble in hexanes, acetonitrile, methanol, ethanol, and isopropanol. The polymer film was damaged by exposure to acetone, but the film was not dissolved.

### Example 10

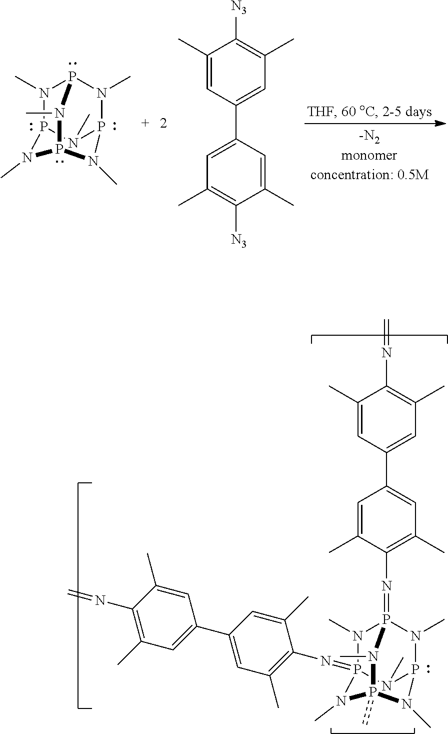

Inside a glovebox, a solution of a compound according to Formula I where R₁ is methyl (0.030 g, 0.101 mmol) in 0.3 mL THF and a solution of 4,4′-diazido-3,3′,5,5′-tetramethyl-1,1′-biphenyl (0.059 g, 0.201 mmol) in 0.3 mL THF were mixed to obtain a clear yellow solution. The reaction solution was then transferred to a 25 mL pressure tube equipped with a threaded PTFE, capped, and heated to 60° C. in an oil bath for two days, without stirring. A red hard gel was obtained. Volatiles were removed under vacuum to obtain a red hard solid. The solid material was soaked in THF overnight to obtain a soft gel again. This gel can absorb almost 80% (w/w) of its weight in THF. Similarly, this gel swells in dichloromethane, acetone, ethyl acetate, DMF, toluene, and xylene. The gel was washed by repeating the swelling two more times and replacing the THF with fresh THF in each round. Finally, the gel was dried under vacuum to obtain a hard solid. The solid was crushed with a mortar and pestle for analysis by ³¹P, and ¹H solid-state NMR spectroscopy. The ³¹P NMR spectrum indicates that three of the four phosphorous sites participate in the network.

IR (KBr pellet, cm⁻¹): 3426, 2922, 2851, 2359, 2340, 2175, 1472, 1455, 1445, 1434, 1385, 1371, 1360, 1179, 1073, 1023, 887, 858, 733 cm⁻¹.

¹H ssNMR: δ 7.7-5.3 (Ar—H), 3.1-1.2 (N-Me, Ar-Me) ppm.

³¹P ssNMR: δ 140.1 (broad, cage), 71.1 (sharp, cage), 29.3 (sharp, cage), 10.6 (broad, cage), 2.8-0.4 (sharp, cage), −19.3 (broad, cage) ppm.

### Example 11

The synthesis of the polymer of Example 10 was done at lower monomer concentration (0.1 M). Inside a glovebox, a solution of the compound according to Formula I where R₁ is methyl (0.150 g, 0.500 mmol) in 7.5 mL THF and a solution of 4,4′-diazido-3,3′,5,5′-tetramethyl-1,1′-biphenyl (0.294 g, 1.01 mmol) in 7.5 mL THF were mixed to obtain a clear yellow solution and then transferred to a 25 mL pressure tube equipped with a threaded PTFE and was tightly capped. The reaction was done at 60° C. for one day, without stirring which led to the formation of a bright orange soft polymer gel. The progress of the reaction has been monitored through ³¹P NMR. Volatiles were removed under vacuum to obtain an orange solid. This solid can absorb almost 180% (w/w) of its weight in THF. The final solid product was crushed with a mortar and pestle for analysis by ³¹P, and ¹H solid-state NMR spectroscopy.

¹H ssNMR: δ 6.8 (Ar—H), 3.0-1.1 (N-Me, Ar-Me) ppm.

¹³C ssNMR: δ 141.6 (Ar—C), 130.4-126.0 (Ar—C), 30.9 (N-Me), 19.8 (Ar-Me) ppm.

³¹P ssNMR: δ 72.5 (sharp, cage), −17.9 (sharp, cage) ppm.

### Example 12

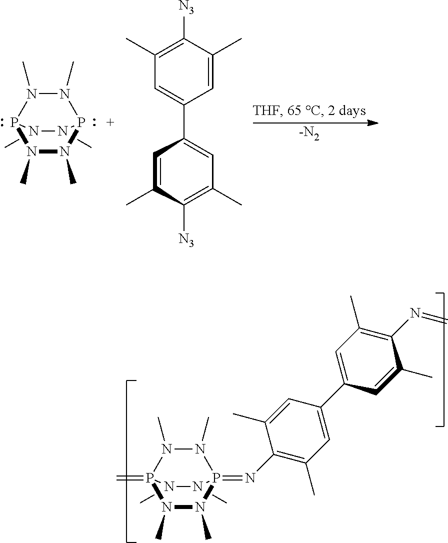

Inside a glovebox and in a pressure tube equipped with a threaded PTFE, a solution of the compound of Formula II where R₂ is methyl (0.050 g, 0.211 mmol) in 1 mL THF was mixed with a solution of 4,4′-diazido-3,3′,5,5′-tetramethyl-1,1-biphenyl (0.062 g, 0.211 mmol) in 1 mL THF. The tube was capped and heated to 65° C. in an oil bath while stirring. After around 2 h, the formation of a yellowish suspension containing white precipitate was observed. The reaction continued under heat for 2 days. The precipitate was isolated using centrifugation and characterized via ³¹P ssNMR. The ³¹P NMR of the supernatant confirmed the complete consumption of the compound of Formula II where R₂ is methyl.

IR (NaCl plate, cm⁻¹): 2934, 2895, 2101, 2063, 1479, 1445, 1369, 1251, 1198, 1129, 1056, 965, 861, 768, 737, 663 cm⁻¹.

¹H ssNMR: δ 7.3 (Ar—H), 2.1 (N-Me, Ar-Me) ppm.

³¹P ssNMR: δ 96.6 (weak, cage), 6.5-2.5 (weak, cage), −19.5 (sharp, cage) ppm.

Polymer molecular weight measured by DOSY-NMR: >2,500 g/mol.

### Example 13

The polymeric reaction product of Example 12 was tested to determine its solubility in DMSO, DMF, CHCl₃, toluene, CH₂Cl₂, ethanol, acetic acid, and sulfuric acid.

Although the reaction product of Example 12 is insoluble in the above-mentioned solvents, in sulfuric acid a sharp color change from colorless to purple was observed and the ³¹P NMR showed the appearance of an insignificant P peak at 23.4 ppm.

### Example 14

The reaction of Example 12 was repeated while varying the solvent, temperature, and concentration.

Performing the reaction in dimethyl formamide (DMF) led to the formation of a white precipitate. Performing the reaction at room temperature led to the formation of a white precipitate. Performing the reaction using 0.2M and 0.05 M monomer concentrations led to the formation of a white precipitate.

### Example 15

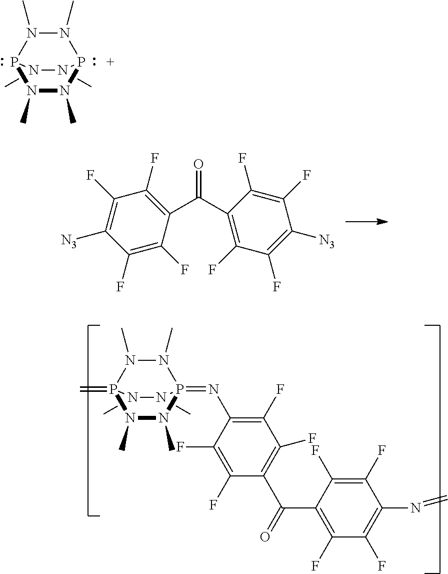

Inside a glovebox and in a pressure tube equipped with a threaded PTFE, a solution of a compound of Formula II where R₂ is methyl (0.200 g, 0.846 mmol) in 4.23 mL THF was mixed with a solution of bis(4-azido-2,3,5,6-tetrafluorophenyl)methanone (0.330 g, 0.846 mmol) in 4.23 mL THF which formed a clear yellow solution with slight emergence of N₂ bubbles. The tube was capped, and the mixture was allowed to react at room temperature with stirring. After two days and upon completion (monitored using ³¹P NMR), the solvent was removed in vacuo. The product was redissolved in THF and was characterized via ¹H NMR, ¹³C NMR, ¹⁹F NMR, ³¹P NMR, and IR spectroscopy.

IR (NaCl plate, cm⁻¹): 2969, 2939, 2901, 2872, 2118, 1673, 1640, 1557, 1485, 1408, 1336, 1278, 1206, 1114, 1060, 1014, 983, 938, 865, 771, 738, 717, 675, 648, 611 cm⁻¹.

¹H NMR (300 MHz, THF-d8): 3.05-3.01 (m, 18H, N-Me) ppm.

¹³C{¹H} NMR (101 MHz, THF-d8): 176.37 (s, —CO), 146.91-146.66 (m, C_{Ar}), 144.40-144.16 (m, C_{Ar}), 143.10-142.88 (m, C_{Ar}), 140.67-140.55 (m, C_{Ar}), 130.18-129.89 (m, C_{Ar}), 109.51 (t, J=15 Hz, C_{Ar}—CO), 35.95-35.92 (m, N-Me) ppm.

³¹P NMR (162 MHz, THF-d8): −3.65 (s, 2P, cage) ppm.

¹⁹F NMR (377 MHz, CDCl₃): −140. 13 to −145.29 (m, 4F), −152.70 to −152.87 (m, 4F) ppm.

Polymer molecular weight (Mw) measured by diffusion-ordered NMR spectroscopy (DOSY): 25,000 g·mol⁻¹. Diff con.=1.39 E⁻¹⁰

### Example 16

The reaction illustrated in Example 15 was performed at an alternative monomer concentration and reaction temperature.

Inside a glovebox, a solution of the compound of Formula II where R₂ is methyl (0.030 g, 0.127 mmol) in 0.56 mL THF was mixed with a solution of bis(4-azido-2,3,5,6-tetrafluorophenyl)methanone (0.050 g, 0.127 mmol) in 0.56 mL THF which formed a clear yellow solution with slight emergence of N₂ bubbles. The solution was transferred to an NMR tube and the reaction continued at 60° C. After two days, the formation of a very viscous solution was observed which resembled polymer gels. The reaction was monitored with liquid state ³¹P NMR, and the data confirmed the conversion of the starting material to the final polymer. Spectroscopic data matched Example 15, but molecular weight was much higher, requiring the use of DMF as the solvent.

Polymer molecular weight measured by GPC: Three fractions were detected with molecular weights 11,508 g·mol⁻¹ (Mₙ), 17,862 g·mol⁻¹ (M_{w}) for the 1^{st} fraction, 2,443,403 g·mol⁻¹ (Mₙ), 2,504,037 g·mol⁻¹ (M_{w}) for the 2^{nd} fraction, and 11,127,623 g·mol⁻¹ (Mₙ), 14,571,043 g·mol⁻¹ (M_{w}) for the 3^{rd} fraction. The 3^{rd} fraction was the major fraction.

### Example 17

The reaction illustrated in Example 15 was performed at an alternative monomer concentration and reaction temperature.

Inside a glovebox and in a pressure tube equipped with a threaded PTFE, a solution of the compound of Formula II where R₂ is methyl (0.100 g, 0.423 mmol) in 4.2 mL THF was mixed with a solution of bis(4-azido-2,3,5,6-tetrafluorophenyl)methanone (0.165 g, 0.423 mmol) in 4.2 mL THF forming a clear yellow solution with slight emergence of N₂ bubbles. The tube was capped, and the mixture was allowed to react at room temperature with stirring. After two days and upon completion (monitored using ³¹P NMR), the solvent was removed in vacuo. The crude compound can be redissolved in THF.

Polymer molecular weight measured by GPC: Three fractions were detected with molecular weights 11,508 g·mol⁻¹ (Mₙ), 17,862 g·mol⁻¹ (M_{w}), for the 1^{st} fraction, 2,336,744 g·mol⁻¹ (Mₙ), 2,419,490 g·mol⁻¹ (M_{w}) for the 2^{nd} fraction, and 7,880,485 g·mol⁻¹ (Mₙ), 8,970,727 g·mol⁻¹ (M_{w}) for the 3^{rd} fraction. The 1^{st} fraction was the major fraction.

### Example 18

The reaction illustrated in Example 15 was performed at an alternative monomer concentration and reaction temperature.

Inside a glovebox and in a pressure tube equipped with a threaded PTFE, a solution of the compound of Formula II where R₂ is methyl (0.100 g, 0.423 mmol) in 1.41 mL THF was mixed with a solution of bis(4-azido-2,3,5,6-tetrafluorophenyl)methanone (0.165 g, 0.423 mmol) in 1.41 mL THF forming a clear yellow solution with slight emergence of N₂ bubbles. The tube was capped, and the mixture was allowed to react at room temperature with stirring. The reaction stayed in liquid form during the first 24 h, however, it formed a very viscous gelatinous polymer in the second day, which is believed to be due to the extremely high molecular weight. The solvent was removed under vacuum and formed a hard yellow polymeric solid. The solvent uptake experiment has been done upon which the polymer absorbed almost 1500% of its weight in THF over two days.

IR (NaCl plate, cm⁻¹): 3647, 2960, 2361, 2116, 1671, 1637, 1541, 1485, 1408, 1275, 1059, 985, 738, 674, 611 cm⁻¹.

### Example 19

The reaction illustrated in Example 15 was performed at an alternative monomer concentration and reaction temperature.

Inside a glovebox and in a pressure tube equipped with a threaded PTFE, a solution of the compound of Formula II where R₂ is methyl (0.100 g, 0.423 mmol) in 1.1 mL THF was mixed with a solution of bis(4-azido-2,3,5,6-tetrafluorophenyl)methanone (0.165 g, 0.423 mmol) in 1.1 mL THF forming a clear yellow solution with slight emergence of N₂ bubbles. The tube was capped, and the mixture was allowed to react at room temperature upon stirring. The reaction ended up with the formation of a very viscous gelatinous polymer during the first day, due to the formation of very high molecular weight polymers. The solvent was removed under vacuum and formed a hard yellow polymeric solid. The polymer absorbed almost 1300% of its weight in THF over two days.

Confirmation of Reaction of Phosphorus-Nitrogen Monomer with Azide

To rule out the possibility of an Aza-Wittig reaction between the phosphorus-nitrogen monomer and the ketone in the bis(4-azido-2,3,5,6-tetrafluorophenyl)methanone, a solution of the compound of Formula II where R₂ is methyl in THF was reacted with H₂O₂ to form the corresponding phosphine oxide derivative of the compound of Formula II. The ³¹P NMR spectra of the resulting bis-phosphine oxide showed a P peak at 9 ppm, in contrast to the P peak of the polymers formed in Examples 15 and 16, which showed a P peak at about −3.6 ppm.

### Example 20

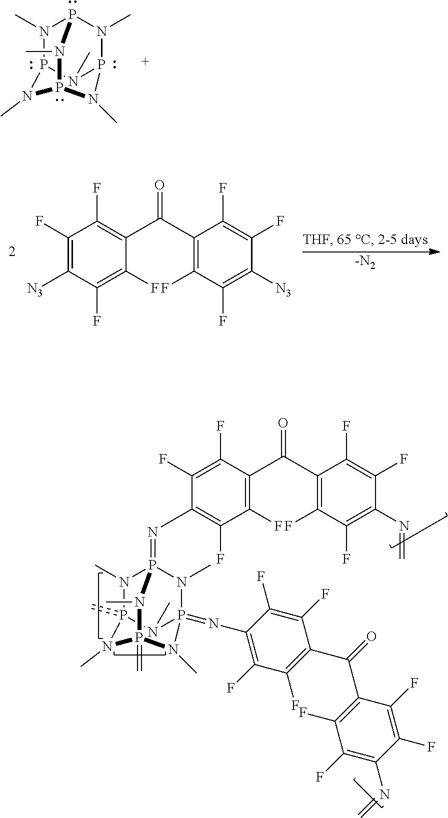

Inside the glovebox and in a pressure tube equipped with a threaded PTFE, a solution of the compound of Formula I where R₁ is methyl (0.060 g, 0.201 mmol) in 1.2 mL THF was mixed with a solution of bis(4-azido-2,3,5,6-tetrafluorophenyl)methanone (0.157 g, 0.402 mmol) in 1.2 mL THF, forming a clear yellow solution with slight emergence of N₂. The reaction vessel was capped and heated at 65° C. without stirring, leading to the formation of a yellow gel after one day. After 5 days, the heat stopped, and the solvent was removed from the reaction vessel and replaced with fresh THF. This process was repeated three times to reach the pure desired product. Volatiles were removed under vacuum to obtain a hard, orange solid. The solid material was soaked in THF overnight to form a soft gel. The adsorbed THF was measured. This network absorbed 346% (w/w) of its weight in THF. Finally, the gel was dried under vacuum and crushed with a mortar and pestle for IR spectroscopy.

IR (NaCl plate, cm⁻¹): 2957, 2891, 2827, 1644, 1538, 1486, 1409, 1282, 1158, 1021, 989, 955, 899, 768, 676 cm⁻¹.

### Example 21

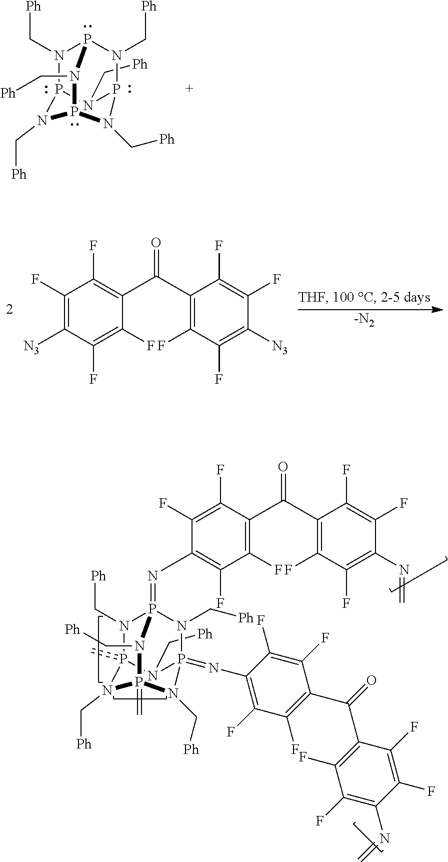

Inside the glovebox and in a pressure tube equipped with a threaded PTFE, a solution of the compound of Formula I where R₁ is —CH₂Ph (0.054 g, 0.0716 mmol) in 0.4 mL THF and a solution of bis(4-azido-2,3,5,6-tetrafluorophenyl)methanone (0.055 g, 0.143 mmol) in 0.4 mL THF were mixed leading to the formation of a clear yellow solution. The tube was capped tightly, and the reaction continued at 100° C. After one day there was a sharp color change from yellow to dark brown. After almost 2 day of the reaction, the formation of a dark solid was observed. The ³¹P NMR of the supernatant confirmed the complete consumption of the compound of Formula I. The reaction continued for 5 days to make sure the complete conversion of the starting materials. Finally, the heat was stopped, and the solvent was replaced with fresh THF and this was repeated three times over three days to remove the unreacted materials and other impurities. Volatiles were removed under vacuum to obtain a hard, orange solid. The solid material was soaked in THF overnight to form a soft gel. The adsorbed THF was measured. This network absorbed 375% (w/w) of its weight in THF. Finally, the gel was dried under vacuum and crushed with a mortar and pestle for IR spectroscopy.

IR (NaCl plate, cm⁻¹): 3085, 3063, 3030, 2933, 2864, 2126, 1952, 1809, 1644, 1538, 1482, 1399, 1310, 1257, 1205, 1310, 1257, 1205, 1093, 1022, 979, 933, 871, 840, 766, 694 cm⁻¹.

### Example 22

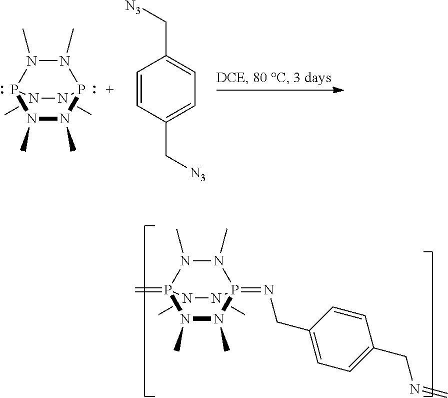

Inside the glovebox, the compound of Formula II where R₂ is methyl (0.1 g, 0.423 mmol) was dissolved in 2.1 mL DCE in a pressure tube equipped with a threaded PTFE. A solution of 1,4-bis(azidomethyl)benzene (0.796 g, 0.423 mmol) in 2.1 mL THF was added to the pressure tube and the reaction was continued at 80° C. upon stirring. The formation of white precipitate was observed. ³¹P NMR monitoring confirmed the complete consumption of the starting material and the formation of a sharp peak at 2.1 ppm as the product of the reaction. After 3 days, the reaction stopped, and the precipitate was isolated via centrifugation. The supernatant was cast on a Teflon pan. However, it led to the formation of a flaky film.

IR (NaCl plate, cm⁻¹): 2952, 2929, 2891, 2814, 2096, 1694, 1607, 1508, 1458, 1438, 1369, 1331, 1235, 1196, 1108, 1055, 1018, 959, 929, 801, 730, 663 cm⁻¹.

### Example 23

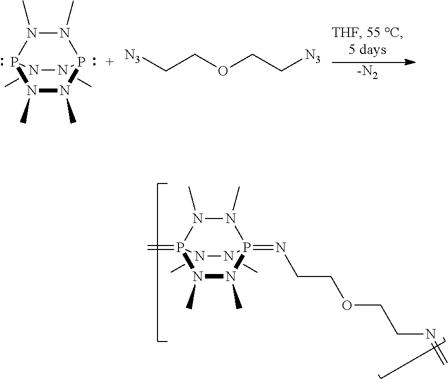

Inside a glovebox, the compound of Formula II where R₂ is methyl (236.2 g/mol, 6.40 mmol, 1.51 g, 1 eq.) was added to a 60 mL pressure tube equipped with a stir bar and dissolved in THF (2.5 mL). 1,5-Diazido-3-oxapentane (156.15 g/mol, 6.40 mmol, 1.0 g, 1 eq.) was weighed into a 4-dram vial and dissolved in THF (2.5 mL) then transferred to the pressure tube and the reaction was capped with a threaded PTFE cap. The reaction was heated to 60° C. in an oil bath for five days. Upon cooling the reaction to room temperature, a white precipitate crashed out. The polymer was purified by washing with pentane and drying under reduced pressure to isolate the polymer as a white powder. This polymer shows excellent water solubility.

IR (NaCl plate, cm⁻¹): 2925, 2893, 2853, 2361, 2341, 1461, 1437, 1404, 1341, 1304, 1277, 1239, 1198, 1112, 1056, 960, 837, 770, 720, 666 cm⁻¹.

¹H NMR (400 MHz, CDCl₃): δ 3.49 (ap. t, J=6.8 Hz, 4H), 3.37-3.19 (m, 4H), 2.86 (t, J=5.52 Hz, 18H) ppm.

³¹C {¹H} NMR (100 MHz, CDCl₃): δ 74.6 (t, ²J_{P-C}=8.7 Hz), 43.3, 37.0 ppm.

³¹P {¹H} NMR (162 MHz, CDCl₃): δ 1.36 ppm.

### Example 24

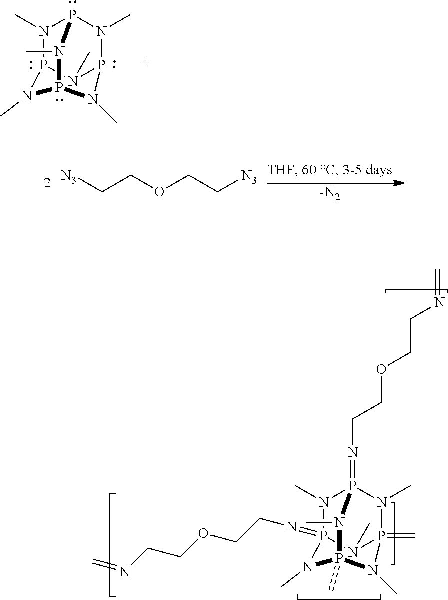

Inside a glovebox, a solution of a compound of Formula I where R₁ is methyl (0.477 g, 1.60 mmol, 1 eq.) in 1.5 mL THF was made in 60 mL pressure tube and a solution of 1,5-diazido-3-oxapentane (0.50 g, 3.20 mmol. 2 eq.) in 1.5 mL THF was made in 4-dram vial. The solution of the 1,5-diazido-3-oxapentane was added to the solution of the compound of Formula I and the reaction was sealed with a threaded PTFE and was tightly capped. The reaction was heated to 60° C. for 4 days, without stirring which led to the formation of a colourless soft polymer gel. Volatiles were removed under vacuum to obtain the dry colourless solid. This solid reversibly absorbs approximately 200% of its weight in water to form a hydrogel.

IR (KBr plate, cm⁻¹): 3644, 3423, 3329, 2848, 2361, 2341, 2103, 1459, 1397, 1347, 1307, 1275, 1182, 1125, 1058, 946, 911, 780, 661 cm⁻¹.

### Example 25

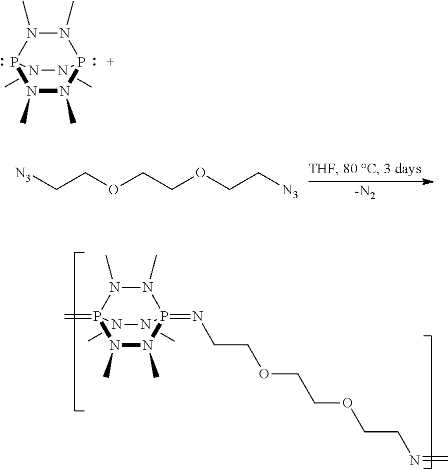

Inside a glovebox, a compound of Formula II where R₂ is methyl (236.2 g/mol, 4.45 mmol, 1.05 g, 1 eq.) was added to a 60 mL pressure tube equipped with a stir bar and dissolved in THF (2.5 mL). 1,8-diazido-3,6-dioxaoctane (200.2 g/mol, 4.45 mmol, 0.89 g, 1 eq.) was weighed into a 4-dram vial and dissolved in THF (2.5 mL) then transferred to the pressure tube and the reaction was capped with a threaded PTFE cap. The reaction mixture was heated to 80° C. in an oil bath for five days. Upon cooling the reaction mixture to room temperature, a white precipitate crashed out. The polymer was purified by washing with pentane and drying under reduced pressure to isolate the polymer as a white powder. This polymer shows excellent water solubility.

IR (NaCl plate, cm⁻¹): 3416, 3210, 2934, 2891, 1659, 1651, 1599, 1461, 1439, 1405, 1342, 1306, 1275, 1199, 1120, 1057, 962, 666 cm⁻¹.

¹H NMR (400 MHz, CDCl₃): δ 3.59 (s, 4H), 3.48 (ap. t, J=6.7 Hz, 4H), 3.38-3.31 (m, 4H), 2.85 (t, J=5.5 Hz, 18H) ppm.

³¹C {¹H} NMR (100 MHz, CDCl₃): δ 74.8 (t, ²J_{P-C}=8.5 Hz), 70.5, 43.1, 37.0 ppm.

³¹P {¹H} NMR (162 MHz, CDCl₃): δ 1.40 ppm.

### Example 26

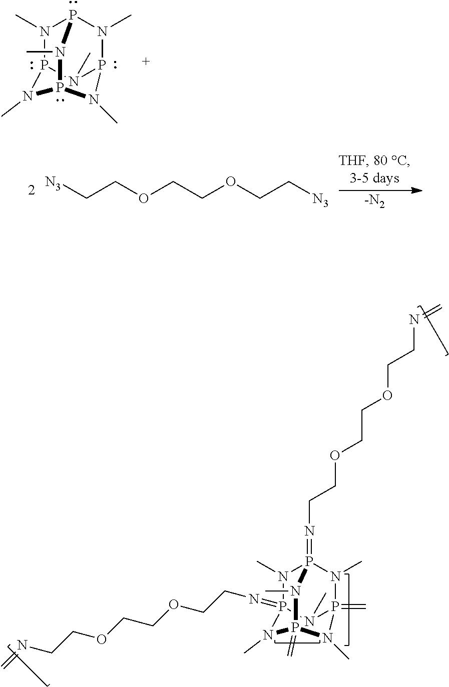

Inside a glovebox, a solution of a compound of Formula I where R₁ is methyl (0.372 g, 1.25 mmol, 1 eq.) in 1.5 mL THF was made in 60 mL pressure tube and a solution of 1,8-diazido-3,6-dioxaoctane (0.50 g, 2.50 mmol. 2 eq.) in 1.5 mL THF was made in 4-dram vial. The solution of the 1,8-diazido-3,6-dioxaoctane was added to the solution of the compound of Formula I and the reaction was sealed with a threaded PTFE and was tightly capped. The reaction was heated to 80° C. for 4 days, without stirring which led to the formation of a colourless soft polymer gel. Volatiles were removed under vacuum to obtain the dry pale-yellow solid, which was crushed with a mortar and pestle for analysis by ³¹P, and ¹H solid-state NMR spectroscopy. This solid reversibly absorbs approximately 200% of its weight in water to form a hydrogel.

¹H ssNMR: δ 3.6, 3.0, 1.8 ppm.

³¹P ssNMR: δ 15.6, 12.2 ppm.

In the preceding description, for purposes of explanation, numerous details are set forth in order to provide a thorough understanding of the examples. However, it will be apparent to one skilled in the art that these specific details are not required. Accordingly, what has been described is merely illustrative of the application of the described examples and numerous modifications and variations are possible in light of the above teachings.

Since the above description provides examples, it will be appreciated that modifications and variations can be effected to the particular examples by those of skill in the art. Accordingly, the scope of the claims should not be limited by the particular examples set forth herein, but should be construed in a manner consistent with the specification as a whole.

1. A polymeric reaction product formed from the polymerization of:
(A) a phosphorus-nitrogen monomer according to Formula I, a phosphorus-nitrogen monomer according to Formula II, or a combination thereof; and
(B) a monomer comprising a compound including at least two azide functional groups,
wherein:
the structure of Formula I is: 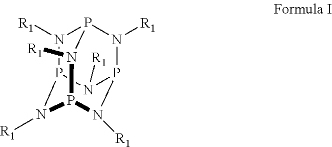
wherein each R₁ is independently an optionally substituted C₁-C₆ alkyl or C₂-C₆alkenyl;
and
the structure of Formula II is: 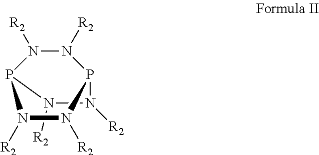
wherein each R₂ is independently an optionally substituted C₁-C₆ alkyl or C₂-C₆alkenyl.

2. The polymeric reaction product according to claim 1, wherein each optional substituent for R₁ and R₂ is independently selected from the group consisting of: D, halogen, an optionally substituted straight chain or branched alkyl group, an optionally substituted alkenyl group, an optionally substituted alkynyl group, an optionally substituted aryl group, an optionally substituted heteroaryl group, or an optionally substituted carbocyclic group.

3. The polymeric reaction product according to claim 2, wherein each R₁ and R₂ is independently methyl, ethyl, benzyl, vinyl, allyl, —(CH₂)ₙ—CH═CH₂ where n is from 1 to 10, or —(CH₂)ₘ-Ph-CH═CH₂ where m is from 1 to 5.

4. The polymeric reaction product according to any one of claims 1 to 3, wherein the monomer (B) comprises a mixture of different azide-containing compounds.

5. The polymeric reaction product according to any one of claims 1 to 4, wherein the polymeric reaction product lacks 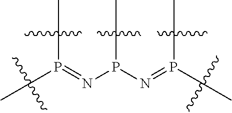
groups.

6. The polymeric reaction product according to any one of claims 1 to 5, wherein at least one, and preferably all, of the azide functional groups in monomer (B) is bonded to a carbon atom.

7. The polymeric reaction product according to any one of claims 1 to 6, wherein the monomer (B) comprises a compound with a structure according to N₃-A-N₃, wherein A is a linking group, such as an linking group comprising one or more of: a metal, an optionally substituted straight chain or branched alkyl, an optionally substituted alkenyl, an optionally substituted alkynyl, an optionally substituted aryl, an optionally substituted heteroaryl, an optionally substituted carbocyclic, an optionally substituted heteroborane such as an optionally substituted carboranyl, or a phosphorus-nitrogen structure according to Formula II.

8. The polymeric reaction product according to claim 7, wherein A is a linking group comprising one or more aryl groups substituted with at least one electron-withdrawing functional group, such as —F, —CF₃, —C₂F₅, —NO₂, —Cl, —SO₂R′, carbonyl, —SF₅, —NR′₃⁺, —CO₂R′, or —C₆F₅, wherein each R′ is independently an optionally substituted straight chain or branched alkyl group, an optionally substituted alkenyl group, an optionally substituted alkynyl group, an optionally substituted aryl group, an optionally substituted heteroaryl group, an optionally substituted carbocyclic group.

9. The polymeric reaction product according to claim 7 or 8, wherein the monomer (B) comprises a compound according to: 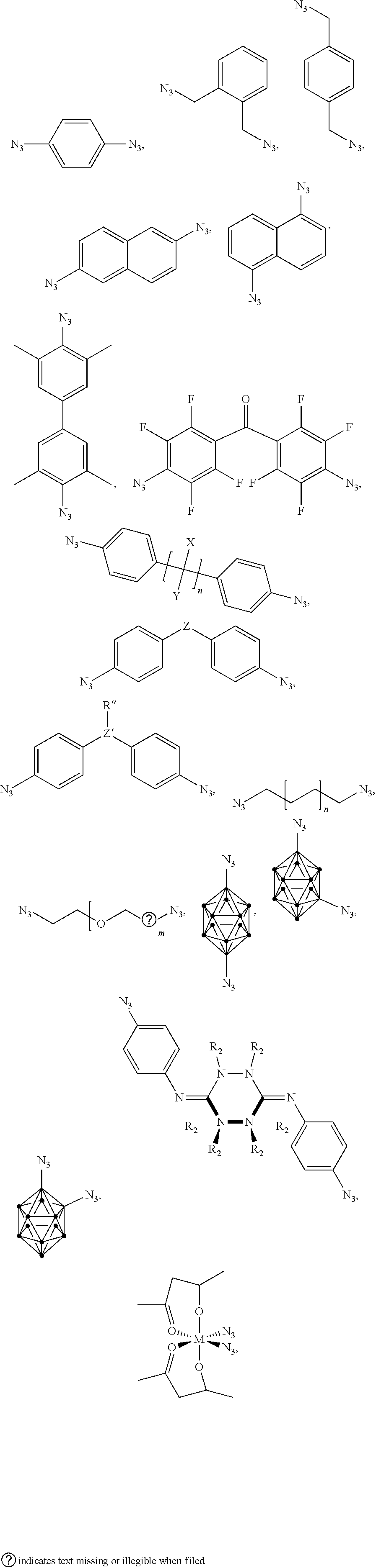 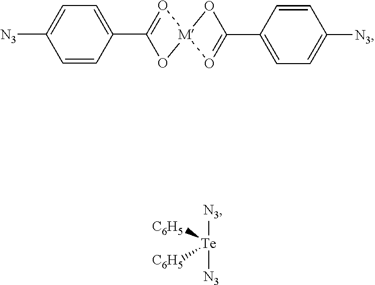
or any EWG substituted-aryl variant thereof, such as 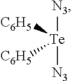
wherein X is H, D, halogen, an optionally substituted straight chain or branched alkyl group, an optionally substituted alkenyl group, an optionally substituted alkynyl group, an optionally substituted aryl group, an optionally substituted heteroaryl group, or an optionally substituted carbocyclic group;
wherein Y is H, D, halogen, an optionally substituted straight chain or branched alkyl group, an optionally substituted alkenyl group, an optionally substituted alkynyl group, an optionally substituted aryl group, an optionally substituted heteroaryl group, or an optionally substituted carbocyclic group;
wherein n is an integer from 1 to 3;
wherein m is an integer from 1 to 1000;
wherein Z is bond or a linker comprising: —O—, —NR₃—, a carbonyl, an ester, an ether, an amide, an optionally substituted C₁-C₆ alkyl group, an optionally substituted aryl group, —S—, —Se—, —Te—, —S(O)—, —Se(O)—, —Te(O)—, or any combination thereof, wherein R₃ is an optionally substituted alkyl or aryl group;
wherein Z′ is P, As, Sb, or Bi, and R″ is an optionally substituted aryl group;
wherein • is B—H;
wherein each R₂ is independently as defined above;
wherein M is Sn, Ge, or Si; and
wherein M′ is Sc, Ti, Cr, Mn, Fe, Co, Ni, Cu, or Zn, preferably Co or Zn.

10. The polymeric reaction product according to claim 9, wherein the monomer (B) comprises a compound according to: 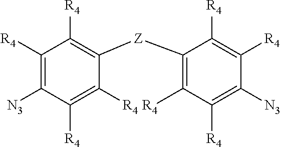
wherein Z is a bond or a linker comprising: —O—, —NR₃—, a carbonyl, an ester, an ether, an amide, an optionally substituted C₁-C₆ alkyl group, an optionally substituted aromatic group, or any combination thereof, wherein R₃ is an optionally substituted alkyl or aryl group; and
wherein each R₄ is independently H or an electron-withdrawing functional group, for example fluorine.

11. The polymeric reaction product according to claim 10, wherein the monomer (B) comprises a compound according to:

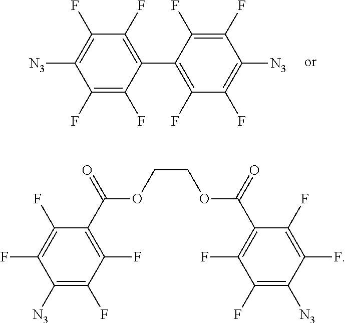 [SMILES: [N-]=[N+]=Nc1c(F)c(F)c(-c2c(F)c(F)c(N=[N+]=[N-])c(F)c2F)c(F)c1F ; [N-]=[N+]=Nc1c(F)c(F)c(C(=O)OCCOC(=O)c2c(F)c(F)c(N=[N+]=[N-])c(F)c2F)c(F)c1F]

12. The polymeric reaction product according to claim 10, wherein the monomer (B) is not

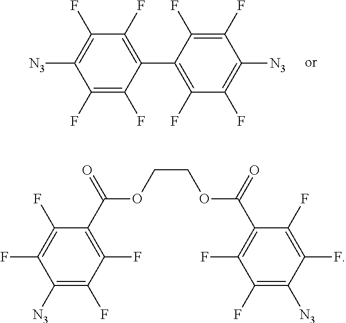 [SMILES: [N-]=[N+]=Nc1c(F)c(F)c(-c2c(F)c(F)c(N=[N+]=[N-])c(F)c2F)c(F)c1F ; [N-]=[N+]=Nc1c(F)c(F)c(C(=O)OCCOC(=O)c2c(F)c(F)c(N=[N+]=[N-])c(F)c2F)c(F)c1F]

13. The polymeric reaction product according to any one of claims 7 to 12, wherein the reaction product of monomer (A) and monomer (B) comprises: 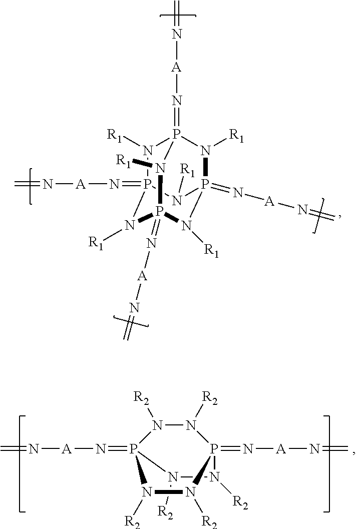
or a combination thereof,
wherein each A may be the same or different.

14. The polymeric reaction product according to any one of claims 7 to 12, wherein the monomer (A) comprises the phosphorus-nitrogen monomer according to Formula I wherein R₁ is ethyl, and wherein the reaction product of monomer (A) and monomer (B) comprises 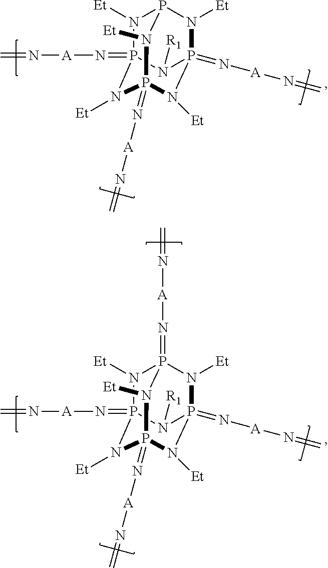
or a combination thereof,
wherein each A may be the same or different.

15. The polymeric reaction product according to any one of claims 1 to 6, wherein the monomer (B) comprises a compound with at least three azide groups linked by: a metal, an optionally substituted straight chain or branched alkyl, an optionally substituted alkenyl, an optionally substituted alkynyl, an optionally substituted aryl, an optionally substituted heteroaryl, or an optionally substituted carbocyclic.

16. The polymeric reaction product according to claim 15, wherein the monomer (B) comprises a compound according to 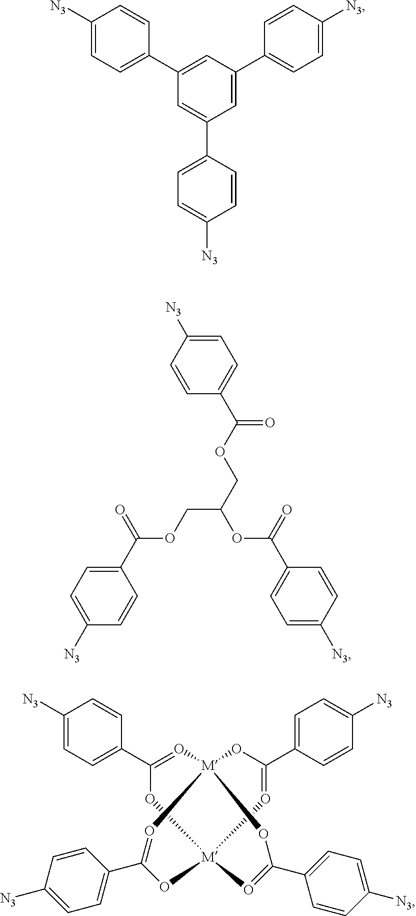
or any EWG substituted-aryl variant thereof,
wherein M′ is Sc, Ti, Cr, Mn, Fe, Co, Ni, Cu, or Zn, preferably Co or Zn.

17. The polymeric reaction product according to claim 16, wherein the monomer (B) comprises a compound according to 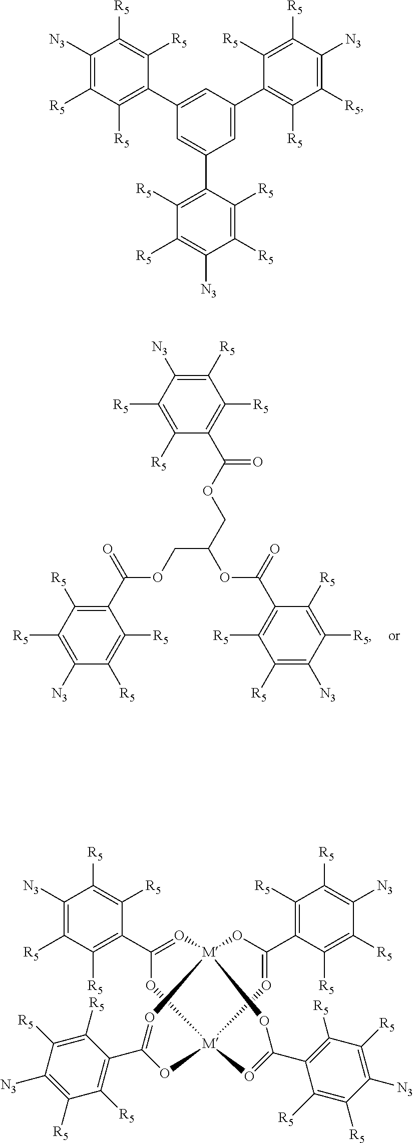
wherein each R₅ is independently H or an electron-withdrawing functional group, for example fluorine.

18. The polymeric reaction product according to any one of claims 1 to 17, wherein the monomer (A) is a mixture of (i) the phosphorus-nitrogen monomer according to Formula I and (ii) the phosphorus-nitrogen monomer according to Formula II in a molar ratio of from 1:100 to 100:1, such as a molar ratio of about 10:90, about 20:80, about 30:70, about 40:60, about 50:50, about 60:40, about 70:30, about 80:20, or about 90:10.

19. The polymeric reaction product according to any one of claims 1 to 18, wherein each R₁ is not methyl.

20. The polymeric reaction product according to any one of claims 1 to 19, wherein each R₂ is not methyl.

21. A process for the preparation of a polymerization reaction product, the process comprising:
reacting (A) a phosphorus-nitrogen monomer according to Formula I, a phosphorus-nitrogen monomer according to Formula II, or a combination thereof with (B) a monomer comprising a compound including at least two azide functional groups under anhydrous polymerization conditions,
wherein:
the structure of Formula I is: 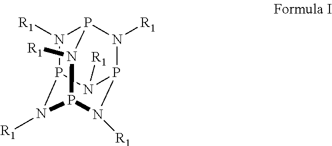
wherein each R₁ is independently an optionally substituted C₁-C₆ alkyl or C₂-C₆alkenyl;
and
the structure of Formula II is: 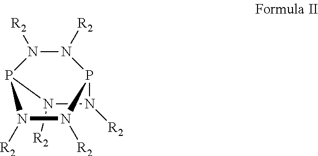
wherein each R₂ is independently an optionally substituted C₁-C₆ alkyl or C₂-C₆alkenyl,
and wherein the polymerization conditions preferably comprise polymerization at an elevated temperature, such as a temperature from about 25 to about 110° C., for example a temperature of about 60° C. to about 110° C., preferably wherein the elevated temperature is provided by a heated oil bath.

22. The process according to claim 21, wherein the reaction of monomer (A) with monomer (B) is in an aprotic solvent, preferably an aprotic solvent with a boiling point of between about 60° C. to about 110° C., such as tetrahydrofuran.

23. The process according to claim 21 or 22, wherein each optional substituent for R₁ and R₂ is independently selected from the group consisting of: D, halogen, an optionally substituted straight chain or branched alkyl group, an optionally substituted alkenyl group, an optionally substituted alkynyl group, an optionally substituted aryl group, an optionally substituted heteroaryl group, or an optionally substituted carbocyclic group.

24. The process according to claim 23, wherein each R₁ and R₂ is independently methyl, ethyl, benzyl, vinyl, allyl, —(CH₂)ₙ—CH═CH₂ where n is from 1 to 10, or —(CH₂)ₘ-Ph-CH═CH₂ where m is from 1 to 5.

25. The process according to any one of claims 21 to 24, wherein the monomer (B) comprises a mixture of different azide-containing compounds.

26. The process according to any one of claims 21 to 25, wherein the polymeric reaction product lacks 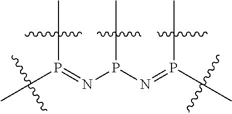
groups.

27. The process according to any one of claims 21 to 26, wherein at least one, and preferably all, of the azide functional groups in monomer (B) is bonded to a carbon atom.

28. The process according to any one of claims 21 to 27, wherein the monomer (B) comprises a compound with a structure according to N₃-A-N₃, wherein A is a linking group, such as an linking group comprising one or more of: a metal, an optionally substituted straight chain or branched alkyl, an optionally substituted alkenyl, an optionally substituted alkynyl, an optionally substituted aryl, an optionally substituted heteroaryl, an optionally substituted carbocyclic, an optionally substituted heteroborane such as an optionally substituted carboranyl, or a phosphorus-nitrogen structure according to Formula II.

29. The process according to claim 28, wherein A is a linking group comprising one or more aryl groups substituted with at least one electron-withdrawing functional group, such as —F, —CF₃, —C₂F₅, —NO₂, —Cl, —SO₂R′, carbonyl, —SF₅, —NR′₃⁺, —CO₂R′, or —C₆F₅, wherein each R′ is independently an optionally substituted straight chain or branched alkyl group, an optionally substituted alkenyl group, an optionally substituted alkynyl group, an optionally substituted aryl group, an optionally substituted heteroaryl group, an optionally substituted carbocyclic group.

30. The process according to claim 28 or 29, wherein the monomer (B) comprises a compound according to: 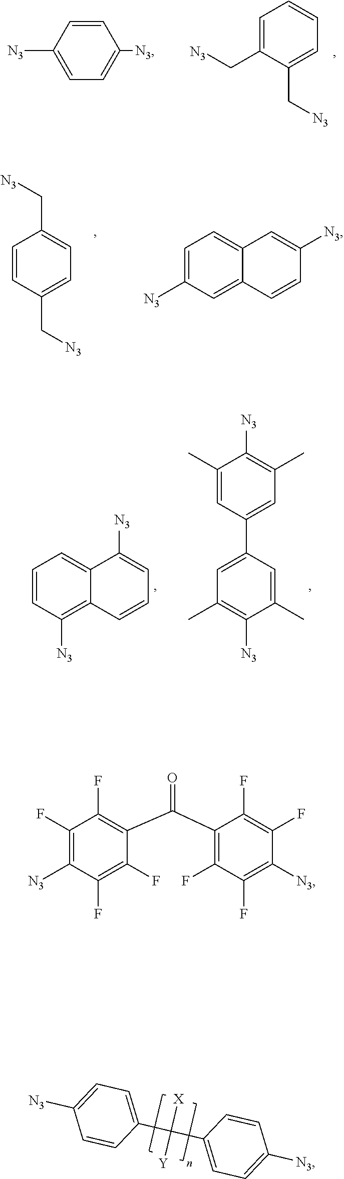 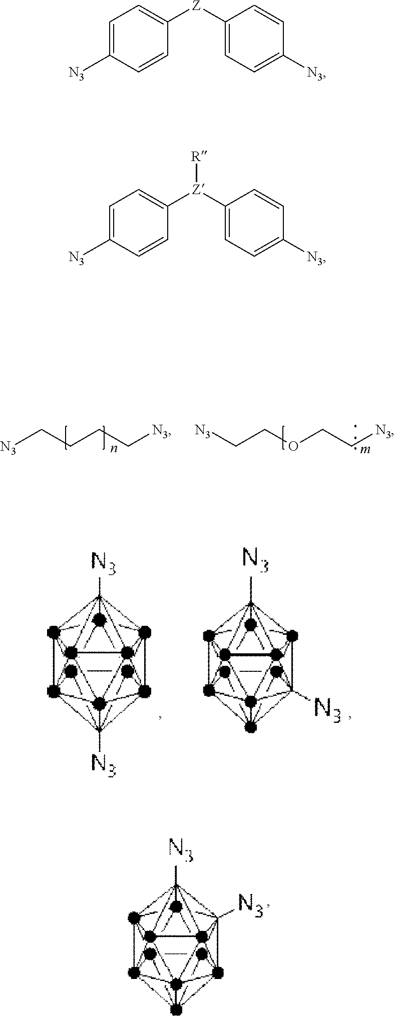 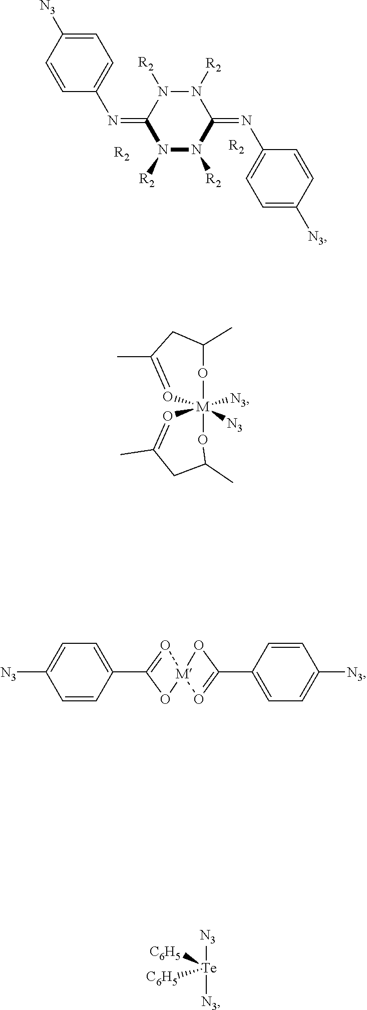 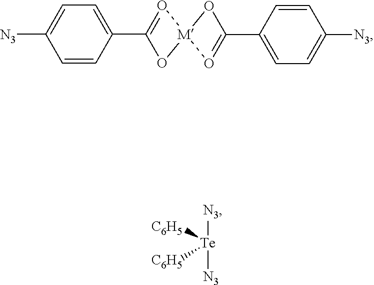
or any EWG substituted-aryl variant thereof, such as 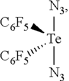
wherein X is H, D, halogen, an optionally substituted straight chain or branched alkyl group, an optionally substituted alkenyl group, an optionally substituted alkynyl group, an optionally substituted aryl group, an optionally substituted heteroaryl group, or an optionally substituted carbocyclic group;
wherein Y is H, D, halogen, an optionally substituted straight chain or branched alkyl group, an optionally substituted alkenyl group, an optionally substituted alkynyl group, an optionally substituted aryl group, an optionally substituted heteroaryl group, or an optionally substituted carbocyclic group;
wherein n is an integer from 1 to 3;
wherein m is an integer from 1 to 1000;
wherein Z is bond or a linker comprising: —O—, —NR₃—, a carbonyl, an ester, an ether, an amide, an optionally substituted C₁-C₆ alkyl group, an optionally substituted aryl group, —S—, —Se—, —Te—, —S(O)—, —Se(O)—, —Te(O)—, or any combination thereof, wherein R₃ is an optionally substituted alkyl or aryl group;
wherein Z′ is P, As, Sb, or Bi, and R″ is an optionally substituted aryl group;
wherein • is B—H,
wherein each R₂ is independently as defined above, and
wherein M is Sn, Ge, or Si; and
wherein M′ is Sc, Ti, Cr, Mn, Fe, Co, Ni, Cu, or Zn, preferably Co or Zn.

31. The process according to claim 30, wherein the monomer (B) comprises a compound according to: 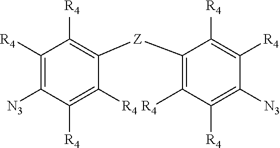
wherein Z is a bond or a linker comprising: —O—, —NR₃—, a carbonyl, an ester, an ether, an amide, an optionally substituted C₁-C₆ alkyl group, an optionally substituted aromatic group, or any combination thereof, wherein R₃ is an optionally substituted alkyl or aryl group; and
wherein each R₄ is independently H or an electron-withdrawing functional group, for example fluorine.

32. The process according to claim 31, wherein the monomer (B) comprises a compound according to:

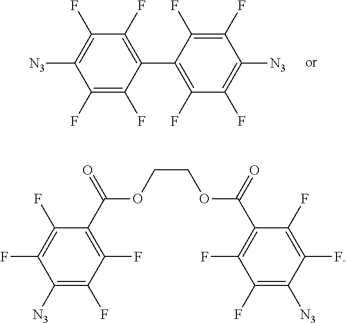 [SMILES: [N-]=[N+]=Nc1c(F)c(F)c(-c2c(F)c(F)c(N=[N+]=[N-])c(F)c2F)c(F)c1F ; [N-]=[N+]=Nc1c(F)c(F)c(C(=O)OCCOC(=O)c2c(F)c(F)c(N=[N+]=[N-])c(F)c2F)c(F)c1F]

33. The process according to claim 31, wherein the monomer (B) is not

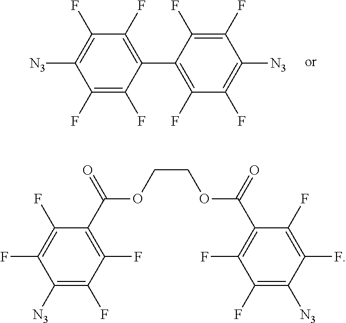 [SMILES: [N-]=[N+]=Nc1c(F)c(F)c(-c2c(F)c(F)c(N=[N+]=[N-])c(F)c2F)c(F)c1F ; [N-]=[N+]=Nc1c(F)c(F)c(C(=O)OCCOC(=O)c2c(F)c(F)c(N=[N+]=[N-])c(F)c2F)c(F)c1F]

34. The process according to any one of claims 28 to 33, wherein the reaction product of monomer (A) and monomer (B) comprises: 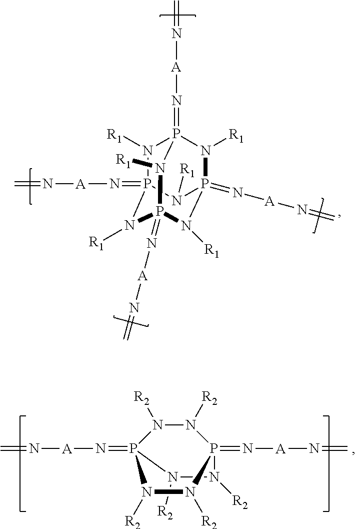
or a combination thereof,
wherein each A may be the same or different.

35. The process according to any one of claims 28 to 33, wherein the monomer (A) comprises the phosphorus-nitrogen monomer according to Formula I wherein R₁ is ethyl, and wherein the reaction product of monomer (A) and monomer (B) comprises 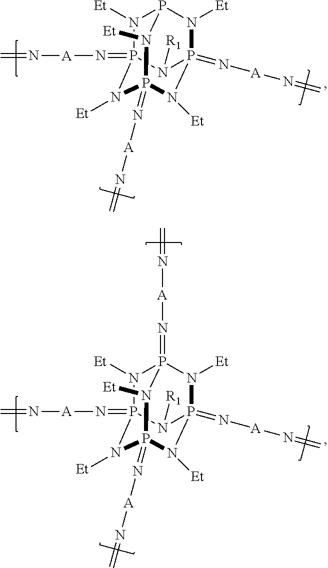
or a combination thereof,
wherein each A may be the same or different.

36. The process according to any one of claims 21 to 27, wherein the monomer (B) comprises a compound with at least three azide groups linked by: an optionally substituted straight chain or branched alkyl, an optionally substituted alkenyl, an optionally substituted alkynyl, an optionally substituted aryl, an optionally substituted heteroaryl, or an optionally substituted carbocyclic.

37. The process according to claim 36, wherein the monomer (B) comprises a compound according to 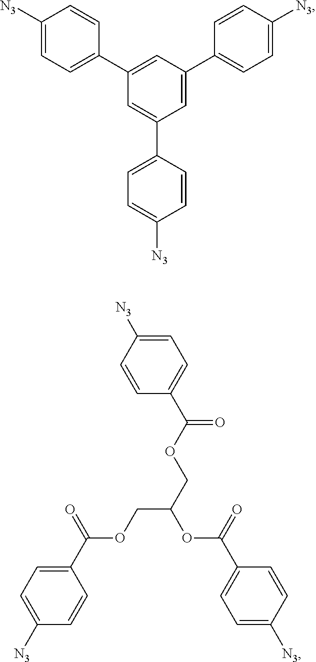 [SMILES: [N-]=[N+]=Nc1ccc(-c2cc(-c3ccc(N=[N+]=[N-])cc3)cc(-c3ccc(N=[N+]=[N-])cc3)c2)cc1 ; [N-]=[N+]=Nc1ccc(C(=O)OCC(COC(=O)c2ccc(N=[N+]=[N-])cc2)OC(=O)c2ccc(N=[N+]=[N-])cc2)cc1] 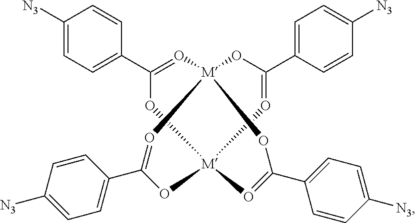
or any EWG substituted-aryl variant thereof,
wherein M′ is Sc, Ti, Cr, Mn, Fe, Co, Ni, Cu, or Zn, preferably Co or Zn.

38. The process according to claim 37, wherein the monomer (B) comprises a compound according to 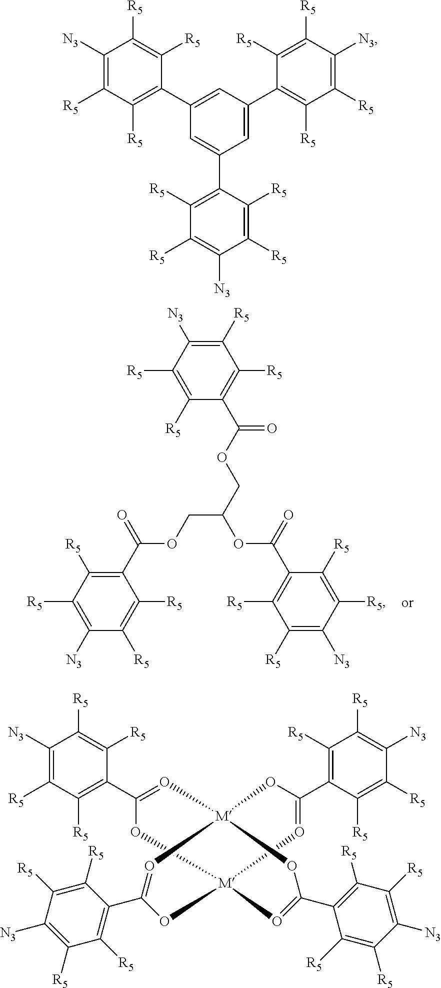
wherein each R₅ is independently H or an electron-withdrawing functional group, for example fluorine.

39. The process according to any one of claims 21 to 38, wherein the monomer (A) is a mixture of (i) the phosphorus-nitrogen monomer according to Formula I and (ii) the phosphorus-nitrogen monomer according to Formula II in a molar ratio of from 1:100 to 100:1, such as a molar ratio of about 10:90, about 20:80, about 30:70, about 40:60, about 50:50, about 60:40, about 70:30, about 80:20, or about 90:10.

40. The process according to any one of claims 21 to 39, wherein each R₁ is not methyl.

41. The process according to any one of claims 21 to 40, wherein each R₂ is not methyl.
